(19) United States
(12) Patent Application Publication
(10) Pub. No.: US 2026/0237985 A1
(43) Pub. Date: Aug. 13, 2026

(54) STRIPPING TOOL, PAIR OF TOOL PARTS, TOOL ELEMENT AND METHOD FOR STRIPPING A CABLE

(71) Applicant: GUSTAV KLAUKE GMBH, Remscheid (DE)

(72) Inventors: Andreas LEHR, Neuss (DE); Egbert FRENKEN, Heinsberg (DE)

(73) Assignee: GUSTAV KLAUKE GMBH, Remscheid (DE)

(21) Appl. No.: 19/160,387

(22) PCT Filed: Feb. 27, 2024
(86) PCT No.: PCT/EP2024/054958

§ 371 Date: Aug. 27, 2025

(30) Foreign Application Priority Data
Feb. 28, 2023 (DE) 10 2023 104 915.1

(51) Int. Cl. H02G 1/12; H02G 1/00

(52) U.S. Cl. CPC H02G 1/1212; H02G 1/005; H02G 1/1256; H02G 1/1273

(57) ABSTRACT

A stripping tool includes a pair of tool jaws, each having a cutting body with at least a first and second partial cutting bodies which can be displaced in opposite axial directions relative to one another. Guide surfaces on the tool part base and the partial cutting bodies are operatively connected to one another and extend at a same obtuse angle. Displacement of the jaws causes displacement of the guide surfaces in the axial direction. The first partial cutting body has a first cutting part or a holding element and the second partial cutting body has a second cutting part facing the first partial cutting body. The cutting body additionally has at least one of the following: an additional holding element arranged on the first partial cutting body, an additional cutting parts arranged on the second partial cutting body.

### FIELD OF TECHNOLOGY

The disclosure initially relates to a stripping tool comprising a pair of tool jaws, which can be brought together in an engagement direction for a stripping process, having a first tool jaw and a second tool jaw, and comprising a pair of tool parts, having a first tool part and a second tool part, for stripping a cable having a cable core and an insulation sheath, whereby each tool part has a cutting body for receiving a partial region of the cable, whereby the cutting body has at least two cutting parts each comprising a cutting tip for acting on the cable during a stripping process, whereby the cutting tip limits a free space of the cutting body, in which it is provided to receive the cable core, whereby the tool part has a tool part base, which is received on the tool jaw, whereby the cutting body has a first partial cutting body and a second partial cutting body, which can be displaced in opposite axial directions relative to one another and relative to the tool part base orthogonally to the engagement direction.

The disclosure furthermore relates to a pair of tool parts for a stripping tool of the above-mentioned type.

The disclosure furthermore relates to a tool element for the releasable connection to a stripping tool of the above-mentioned type.

In addition, a method for stripping a cable having a cable core and an insulation sheath is described, with the method steps:
arranging the cable between two opposite cutting bodies, which each have at least two cutting parts, of a first tool part and of a second tool part;
bringing together the two tool parts in an engagement direction;
cutting an axial partial section of the insulation sheath of the cable by using the cutting parts of the tool parts.

### PRIOR ART

Stripping tools of the type in question as well as pairs of tool parts and tool elements for them and methods for stripping a cable are known. By using stripping tools of this type, a stripping of a cable can at least be prepared in that the insulation sheath of the cable is severed and is pushed forward over an axial partial section along the longitudinal extension of the cable by the cutting parts. After this, the removal of the insulation section, which is separated from the insulation sheath, which remains on the cable side, usually takes place by hand. For example, stripping tools of this type are known from the U.S. Pat. No. 10,554,006 B2, the EP 0 780 943 A1, or the EP 3 718 185 A1 (US 2021/0006049A1).

The stripping tools for notching the insulation sheath can preferably be hydraulically and/or electrically operated devices comprising tool jaws, which can be moved towards one another. The tool parts, which have the cutting parts, can be formed integrally with the tool jaws, or, as usual and generally preferred, can also be replaceably received on the tool jaws. Stripping tools are furthermore known, in the case of which either both tool jaws are formed so as to be actively displaceable onto the respective opposite tool jaw or at least one of the tool jaws is displaceable, while the opposite tool jaw is formed in a stationary manner on the stripping tool.

### SUMMARY OF THE DESCRIPTION

Based on the above-described prior art, the object is to specify a stripping tool of the type in question, a pair of tool parts for a stripping tool and a tool element for the releasable connection to a stripping tool and a method for stripping a cable, by which an advantageous cutting result and an advantageous stripping of a cable section can be attained.

A possible solution of the object is at hand in the case of a stripping tool, which focusses on that the tool part base and the partial cutting bodies have guide surfaces, which are operatively connected to one another and which provide for the displacement, whereby the guide surfaces extend at a same obtuse angle to the engagement direction, whereby an application of force to the cutting body can be attained solely by a displacement of the tool jaws in the engagement direction, which application of force leads to a displacement of the guide surfaces of the cutting body, and thus of the partial cutting bodies, relative to the guide surfaces of the tool part base with a movement component corresponding to the angle in the axial direction, whereby the first partial cutting body has a first cutting parts or a holding element on a front region facing the second partial cutting body, and whereby the second partial cutting body has a second cutting parts on a front region facing the first partial cutting body, and whereby the cutting body additionally has at least one of the following tool elements: an additional holding element arranged on the first partial cutting body, an additional cutting parts arranged on the second partial cutting body.

To create the axial movement component of the partial cutting bodies, the tool part base and the partial cutting bodies have corresponding guide surfaces, in particular corresponding in shape and which are operatively connected to one another and which have corresponding gradients and corresponding gradients and can thus slide one on top of the other. While bringing together the tool parts, a holding force, for example, initially acts on the cutting body or the two partial cutting bodies, respectively, which holding force initially still prevents the axial displacement of the partial cutting bodies. The displacement along the guide surfaces, which slide against one on top of the other, takes place only after overcoming this holding force. The holding force can be given in various ways, as will be described later. The holding force can be attained, for example, by a corresponding setting of a frictional force. However, a positive connection can also be applied, which initially prevents an axial displacement of the partial cutting bodies.

According to the proposed formation of the stripping tool, an advantageous cutting result and stripping result results on the cable. The stripping tool does not only provide for a notching of the insulation sheath of the cable, which is easy in terms of handling, but, in fact, also a shifting or removing, respectively, of a partial insulation section from the cable core. This in particular via an axial partial section, which is significantly larger compared to the prior art, by the provision of an additional additional holding element arranged on the first partial cutting body or of an additional cutting parts additionally arranged on the second partial cutting body. The special function of the additional holding element or additional cutting parts, respectively, will be discussed in more detail later.

The tool part initially has a tool part base, which is mounted in a stationary manner relative to the tool jaw or which is formed integrally with the tool jaw, and a cutting body, which can be displaced relative to the tool part base, comprising two partial cutting bodies. The partial cutting bodies can be displaced in opposite axial directions of the tool part along the oblique guide surfaces, in the direction of the longitudinal extension of a cable arranged between the opposite tool parts.

Starting at an initial position, in which the two partial cutting bodies bear against one another with their front surfaces, the two-piece formation of the cutting body in a first partial cutting body and a second partial cutting body additionally provides for a symmetrical moving apart in a positive axial direction and a negative axial direction, which is opposite to the positive axial direction but parallel thereto. When displacing the two partial cutting bodies away from one another, a displacement of the notched end section of the insulation sheath occurs relative to the cable core, whereby the end section can be removed easily from the cable core in terms of handling. Bringing together the tool jaws thereby effects the notching of the insulation sheath as well as the shifting of the insulation sheath relative to the cable core. Due to the axial shifting, the end-side, notched end section of the insulation sheath can be separated from the remaining insulation sheath, even if the end section has not been completely cut through yet. The force generated in the axial direction can optionally also produce a required tear-off of the insulation sheath from the residual piece, which remains on the cable. Alternatively, the user can also manually remove the notched end section from the residual piece.

In the proposed formation of the cutting body comprising a first partial cutting body and a second partial cutting body, the displacement of the partial cutting bodies relative to one another as part of a stripping process optionally has the result that the tool jaws or the stripping tool as a whole, respectively, is additionally also displaced relative to the cable or the surrounding area, respectively, in particular in the case of cables, the long end of which, which faces away from the free end region, is immovably secured in a surrounding area, which can be the case, for example, in the case of underground cables.

In addition to the cutting parts arranged on the front regions of the first partial cutting body and of the second partial cutting body or a holding element arranged on the first partial cutting body, respectively, and a cutting parts arranged on the second partial cutting body, the cutting body additionally either has an additional holding element on the first partial cutting body or an additional cutting parts on the second partial cutting body. Two different embodiments thus exist.

A first embodiment includes that on its front region, the first partial cutting body has a first cutting parts or a holding element and, on a partial region of the first partial cutting body facing away from the front region, an additional holding element, while the second partial cutting body has a second cutting parts on its front region.

According to a further embodiment, an additional cutting parts, which is formed, for example, for a complete cut-through of the entire cable cross section, can optionally be arranged on the second partial cutting body. According to this embodiment, a simultaneous stripping and cutting through of the cable can then take place, which will be described in more detail later.

A second embodiment provides that, on its front region, the first partial cutting body has a cutting parts or a holding element for the cable, while the second partial cutting body has a cutting parts on its front region and has—spaced apart from the cutting parts—an additional cutting parts spaced apart from the front region. According to this formation, the additional cutting parts does not serve the purpose of a complete severing of the cable, but rather of an “additional stroke” of the stripping tool as part of a second operating step, as will be described in more detail later.

Both embodiments provide for a stripping of the cable over a larger stripping length than compared with a stripping tool, which is common in the prior art, which only has one or two cutting parts, which can only perform a single operating step for stripping the insulation sheath.

According to the embodiments proposed here, however, it is possible to carry out the shifting of the notched axial partial section of the insulation sheath in two operating steps, which are separated from one another in time, whereby the user of the stripping tool initially shifts the slightly cut insulation sheath by a first stripping length relative to the cable core during a first operating step by a displacement of the first tool part towards the second tool part, i.e. by bringing together the tool parts, then displaces the cable in the axial direction relative to the tool parts into a second position, i.e. axially relocates the cable within the stripping tool, and subsequently carries out another bringing together of the tool parts in the reached second position as part of a second partial step, in order to then subsequently displace the partial section of the insulation sheath, which has already been displaced by the first stripping length, by an additional, second stripping length. Compared to the known prior art, the user can thus strip the cable over a much larger length section.

Alternatively to a front-side cutting parts, the first partial cutting body of a tool part can—as already mentioned—also have a holding element, which does not notch the cable to be stripped, but rather only fixes it, for example by a frictional engagement, by a deformation or by fixing elements, which engage at least slightly with the material of the insulation sheath. For example, small needle-shaped holding elements are conceivable.

The stripping tool can carry out a cutting of the insulation sheath and shifting of the insulation sheath relative to the cable core sequentially in time, in that the shifting of the insulation sheath preferably occurs only after overcoming a holding force. The holding force does not yet allow for a movement between the guide surfaces of the cutting body and the tool part base, which are operatively connected. The holding force can be reached by setting the frictional force between the cutting bodies and the insulation sheath. It can be attained by a positive connection. As long as the cutting parts is only in contact with the insulation sheath of the cable, only the frictional forces between the cutting parts and the insulation sheath act on the cutting parts. A self-locking interlocking of the cutting parts preferably results therefrom, in the case of which an axial displacement of the partial cutting bodies relative to the tool part base does not yet take place. A force acting in the axial direction, which displaces the partial cutting bodies along the guide surface relative to the tool part base, is created only when at least partial regions of the opposite cutting parts of the stripping tool come into contact or almost into contact with one another.

This results in a shifting of the notched end section of the insulation sheath relative to the cable core, whereby the end section can either be removed immediately from the cable core or after carrying out a second operating step in terms of handling. Bringing together the tool jaws effects the notching of the insulation sheath as well as the shifting of the insulation sheath relative to the cable core.

When the opposite cutting parts contact one another or contact one another or contact one another except for one or a few millimeters (or fractions thereof), namely when the insulation sheath is severed completely or almost severed completely, the system of the opposite cutting parts can be considered to be a single body, on which two forces act, which oppose one another. The axial force, which effects the displacement of the cutting body or of the two partial cutting bodies, respectively, in the axial direction, then results from the opposing forces, which act essentially transversely to the longitudinal extension of the cable.

When further bringing together the tool parts, after notching the insulation sheath in the initial position of the insulation tool, the situation of the cutting parts, which stabilizes itself, is eliminated and the partial cutting bodies are shifted relative to the tool part base of the tool part. The resulting axial force is, for example, in the magnitude between 10 percent and 20 percent of the applied force of the stripping tool. This is sufficient in order to shift the insulation sheath relative to the cable core even in the case of comparatively large cable cross sections, optionally also with a comparatively hard material of the insulation sheath.

Due to the axial shifting, the end-side, notched end section of the insulation sheath can then be separated from the remaining insulation sheath, even if the end section has not been completely cut through yet. The force generated in the axial direction can optionally also produce a tear-off, which is still required.

Due to the fact that the insulation sheath does not yet have to be cut through completely prior to the displacement of the cutting body relative to the tool part base, a certain distance between the cutting parts and the cable core can be maintained, which prevents a notching of the strands of the cable core.

The above-mentioned principle of the stripping tool can be applied to cables with different outer diameters. The stripping tool is furthermore also suitable for cables, which have several insulation sheaths. The insulation sheath itself can be softer or harder, for example made of rubber, PVC, PE, or others. The cable core of the cable can be massive or can include several strands. The shape of the cutting parts can additionally also be adapted to different cross sectional shapes of the cable, for example to flat cables, sectioned cables, or cables comprising a plurality of separately insulated lines. Provided that the cutting body, in particular the first partial cutting body, has a holding element, the latter can also serve the purpose of holding together the several strands of a cable, in order to avoid a corresponding tearing of the cable core.

The tool parts are preferably designed to cut cross sections between in particular 25 mm² and 300 mm². In practice, the proposed stripping tool has proven itself, for example, for cables, the cable core of which approximately has a diameter of 9 mm to 11 mm, and the insulation sheath of which has an outer diameter of approximately 13 mm to 19 mm. The cutting tip of the cutting parts, which is preferably formed to be semi-circular, can limit, for example, a free space, which has a diameter of 12 mm. In particular an angle of between approx. 20 degrees and approximately 45 degrees has turned out to be favorable as cutting angle of the cutting parts. A cutting angle of approximately 30 degrees is particularly preferred.

The above-mentioned information, however, is to only be understood in an exemplary manner in order to describe the approximately magnitude of the stripping tool or the components thereof, respectively. The information is not to be understood to be limiting in any way.

In addition to the axial displaceability of the cutting body, the tool part itself and/or the cutting body can preferably be pivoted relative to the tool jaw or the tool part base, respectively, about a longitudinal axis corresponding to the axial direction. The pivotability can be given about a comparatively small pivot angle, preferably approximately between 1 degree and 5 degrees. Independently thereof or in addition, the tool part can in particular have a play to the tool jaw, in order to be able to deflect an acting force, which is introduced into the cable to be cut via the tool jaw, during the cutting process, namely so that the cutting parts of the opposite tool parts do not cant or block one another, respectively.

According to a possible embodiment of the stripping tool, a distance between the first cutting parts or the holding element of the first partial cutting body and the additional cutting parts of the second partial cutting body can be smaller in response to contacting front regions of the partial cutting bodies than a first stripping length of the cable, which is stripped by completely bringing together the tool jaws. It is possible with this formation to place the cutting parts or holding element, respectively, of the first partial cutting body and the additional cutting parts of the second partial cutting body, and thus also the second cutting parts of the second partial cutting body located therebetween, for a second stripping step at that point on the cable where the insulation sheath has already been removed by the first stripping length.

During the following second stripping step, the first cutting parts or the holding element of the first partial cutting body, respectively, then supports itself during the axial displacement of the front regions of the partial cutting bodies away from one another on that stripped insulation sheath interface, which belongs to the residual section of the cable, which still remains. During its axial displacement in the opposite direction, the additional cutting parts of the second partial cutting body instead acts against a stripped insulation sheath interface of the end section of the cable, which has already been shifted relative to the cable core in the first stripping step and which has been separated from the remaining residual section of the cable, which remains. As part of the second stripping step, the first cutting parts or the holding element of the first partial cutting body, respectively, and the additional cutting parts of the second partial cutting body thus act like the first cutting parts of the first partial cutting body and the second cutting parts of the second partial cutting body during the first stripping step, for shifting the insulation sheath relative to the cable core.

In terms of the above description, a distance between the first cutting parts or the holding element of the first partial cutting body and the additional cutting parts of the second partial cutting body refers to a distance, which is sufficient to completely receive the cutting parts or holding element, respectively, and the additional cutting parts, so that they do not act on insulation sheath, which still remains on the cable, in the radial direction. The first cutting parts or the holding element of the first partial cutting body, respectively, and the additional cutting parts of the second partial cutting body thus fit into the axial partial section of the cable, which has already been stripped. The double application of the stripping tool on the cable results in a double shifting of the separated partial section of the insulation sheath. For this purpose, the cutting parts or the holding element of the first partial cutting body, respectively, and the additional cutting parts of the second partial cutting parts form a doubling of the pair of the first cutting parts or the holding element of the first partial cutting body, respectively, and the second cutting parts of the second partial cutting body. Even though the additional cutting parts of the second partial cutting body cuts into insulation sheath during a first stripping step, it has no other effect because the additional cutting parts is moved only together with the second partial cutting body and thereby at best supports the shifting of the insulation sheath on the cable core. After the first stripping process, the cable is then displaced by the user within the stripping tool in the axial direction, so that a partial region of the cable, which was slid free, receives the first cutting parts or the holding element of the first partial cutting body, respectively, as well as the additional cutting parts of the second partial cutting body. In response to bringing together the tool parts of the stripping again, another shifting of the already shifted end region of the insulation sheath by a second stripping length then occurs, which is essentially as large as the first stripping length of the first insulation step or slightly smaller than the first stripping length, respectively.

According to a further possible embodiment, the stripping tool can be formed so that a distance between the second cutting parts of the second partial cutting body and the additional holding element of the first partial cutting body is smaller when front regions of the partial cutting bodies contact one another than a (first) stripping length of the cable, which is stripped by completely bringing together the tool jaws. In the case of this embodiment, the additional holding element of the first partial cutting body and the two cutting parts of the first and second partial cutting bodies (or the holding element of the first partial cutting body, respectively) can be inserted into the region of the partial section of the cable, which is stripped during the first stripping step, after carrying out a first stripping step and prior to carrying out a second stripping step. The additional holding element of the first partial cutting body then supports itself against the remaining residual region of the cable during the second stripping step, and the second cutting parts of the second partial cutting body supports itself against the cut front region of the end section of the insulation sheath, which is separated from the residual cable and which has already been shifted with respect to the cable core.

According to this embodiment, the second partial cutting body does not require two blades arranged one behind the other. On the contrary, an element pair, which is effective for the second stripping, is formed from the additional holding element of the first partial cutting body and the second cutting parts of the second partial cutting body.

The additional holding element of the first partial cutting body can either be arranged permanently on the first partial cutting body or can be releasably connected to the first partial cutting body. The user can preferably supplement the additional holding element on the stripping tool, as needed.

After the first stripping process, the additional holding element can be arranged, for example, as clamping element, between a residual section of the insulation sheath, which has not been stripped yet, and the first partial cutting body. Based on the axial displacement direction, the previously shifted free end section of the insulation sheath thereby lies in front of the second cutting parts of the second partial cutting body, thus resulting in an additional shifting of the insulation sheath with respect to the cable core by a second stripping length in response to a subsequent renewed actuation of the stripping tool, namely a further bringing together of the tool parts. During the second stripping step, the additional holding element of the first partial cutting body thus supports itself in the axial direction against the front region of the remaining residual cable on the one hand, while the second cutting parts of the second partial cutting body acts in the opposite axial direction against the front region of the separated and shifted insulation sheath on the other hand.

The additional holding element can be, for example, a clamping element having a wedge-shaped slit, for fixing the cable in the slit in a clamping manner. The additional element can thus be inserted with the slit onto the cable core of the already stripped cable, based on a radial direction, in order to in particular create a contact surface, which acts against the front region of the remaining insulation sheath of the residual cable as part of the second stripping step. Alternatively, the additional holding element can also be embodied differently, for example as an additional holding element, which is in particular formed in two pieces and which engages in a punctiform manner or via a linear circumferential partial section with the cable core.

The additional holding element can, for example, also be pivotably arranged on the first partial cutting body, so that the user can pivot the additional holding element close to the cable as needed, in order to clamp it to the cable core. Two additional holding elements can also be provided, which each engage with opposite sides of the cable. The additional holding elements can engage around the cable core or the insulation sheath from opposite circumferential partial sections. The additional holding element can, for example, also be resiliently mounted. According to one embodiment, the additional holding element can engage with the insulation sheath, which does not result in a noteworthy deformation of the insulation sheath thanks to the resilient mounting. The resiliently mounted additional holding element can thus act against the insulation sheath during the first stripping step and, as soon as a first axial partial section of the cable is stripped, can then dip into the partial section forming a free space, all the way to the cable core, and can fulfill a holding function during the subsequent second stripping step.

It can be provided in any event that the additional holding element can be reversibly connected to the first partial cutting body and/or the cable, so that the additional holding element can be arranged, as needed, so that it can act in a holding manner on the cable, in particular the already stripped partial region of the cable core.

A further embodiment of the stripping tool can provide that the additional cutting parts of the second partial cutting body, based on the completely brought-together end position of the tool jaws, is formed for completely severing the cable, in that a cutting tip of the additional cutting parts leaves no free space for receiving the cable core. According to this embodiment, the additional cutting parts serves the purpose of completely severing the cable in that plane, in which the additional cutting parts is arranged. The above-described effect of the cutting parts or elements, respectively, or additional holding elements, which are additionally present on the partial cutting bodies, is not affected thereby. In this respect, an embodiment of the stripping tool is created, which is designed so that the cutting body can be used simultaneously to strip the cable as well as to completely sever the cable. Provided that the additional cutting parts is formed to be semi-circular, for example, the cutting tip is formed as straight cutting edge, which is in particular oriented parallel to a corresponding cutting tip of the opposite tool part.

According to the above-mentioned embodiment, a stripping tool is created therewith, which can perform a severing as well as stripping of the cable at the same point in time. The additional cutting parts provided for severing the cable can be reversibly connected to the second partial cutting body, as needed. In the event that the user wants a complete severing of the cable, he can then insert the additional cutting parts into the cutting body.

Provided that the user only wants a stripping of the cable but not a severing of the entire cable cross section (including the cable core), he instead uses an additional cutting parts, the cutting tip of which, in the completely brought-together end position of the tool jaws, leaves a free space, in which the cable core of the cable can be received and thus remains intact when stripping the cable.

It is furthermore proposed that the tool part base has a wedge structure comprising at least two guide surfaces, which run towards a common wedge peak in opposite axial directions. The guide surfaces preferably have a wedge angle of between 10 degrees and 20 degrees, preferably approx. 15 degrees, to the axial direction of the tool part. Based on the axial direction of the tool part base, the wedge peak of the wedge structure is preferably essentially arranged in an axial position, which corresponds to the axial position of the cutting tip of the cutting parts in the still non-displaced initial position. This is then preferably simultaneously also that axial position, in which the cutting of the insulation sheath of the cable takes place in the initial position of the stripping tool.

As soon as the insulation sheath is cut through completely or almost completely as part of the first stripping step and the cutting tips of the opposite tool parts thus meet one another or at least further approach one another, the system of the two opposite cutting parts can be considered to be a body, on which forces act, which oppose one another based on the radial direction of the cable and which then result in a total force in the axial direction and displace the cutting body including the cutting parts thereof in the axial direction, whereby the cutting body is shifted on the guide surface of the wedge structure assigned to it. This then lastly effects the stripping of the cable by shifting an end section of the insulation sheath on the cable core. According to one embodiment, the entire surface of the wedge structure can serve as guide surface. It is preferred, however, that only individual, in particular strip-shaped partial regions form the guide surface.

The guide surfaces of the wedge structure thus do not have to cover the entire surface of the sloping or ascending wedge surfaces, respectively. On the contrary, the guide surfaces can only be partial regions of the wedge structure, in particular guide surfaces formed in a strip-shaped manner, which are provided along the respective inclined wedge surface. Each wedge surface can thereby for example in particular also have two parallel guide surfaces. Provided that the strip-shaped guide surfaces are formed in a radially outer region of the tool part base, a direct deflection of the resulting forces to the bottom onto the corresponding tool jaw can be attained, without a curved deviation from a radial center of the tool part base having to initially take place at an edge region. The frictional forces between the guide surfaces of the tool part base and the cutting body are additionally also reduced, which can advantageously promote the axial displacement of the cutting body.

It is possible that the first partial cutting body either has a first cutting parts or a holding element, whereby a first cutting parts of the first tool part does not have be located opposite a first cutting parts of a second tool part. On the contrary, the first cutting parts of the first tool part can also be combined with a holding element of the second tool part, so that the first cutting parts does not act against an opposite cutting tip of a cutting parts but rather against a holding element.

It can furthermore be provided that the stripping tool has an end stop for the cable received in the stripping tool. The axial end stop of the cutting body limits the length of the cable inserted between the tool jaws of the stripping tool. A length of the core of the cable exposed by the stripping can be simultaneously determined therewith. The end stop is preferably used only for the first stripping step, while it is then removed from the end region of the cable after ending the first stripping, for example by linear displacement or pivoting, so that the already shifted section of the insulation sheath can then be shifted even further relative to the cable core during the second stripping process.

The axial end stop can particularly preferably be manually displaced relative to the second partial cutting body by a user of the stripping tool. The end stop can be displaced outwards, for example along a guide rail of the cutting body. It can in particular be provided that, for example, the cutting body has a guide rail, which passes through a partial region of the end stop, and the end stop can thus be displaced towards the tool part or can be displaced away from it, respectively.

A lock, which can fix the end stop in a desired position, is preferably assigned to the end stop. With regard to this, a latch or a screw can be provided, for example, which applies a holding force to the partial region of the cutting body, for example the guide rail.

The two partial cutting bodies of the stripping tool can furthermore be connected by at least one resetting element, whereby a resetting force of the resetting element seeks to move the two partial cutting bodies towards one another. The resetting element can in particular be a spring element, for example a helical spring or a leaf spring, the resetting force of which acts in a direction, which moves the two partial cutting bodies towards one another. Tension springs as well as pressure springs can be used.

The resetting element can end, for example, on a front side of the respective partial cutting body, which faces away from the other partial cutting body. The force is thus applied to the outer sides of the cutting body. The resetting element can connect the partial cutting bodies over the entire axial longitudinal extension thereof. Alternatively, the resetting element can also act against the cutting body on the one hand and against a separate counter bearing on the other hand. The counter bearing can be formed, for example, on a rod-shaped holding element, which passes through the cutting body in the axial direction and onto which a resetting element is pushed on the end side, which is formed, for example, as helical spring and which tensions the partial cutting bodies against one another from outside.

It is furthermore also possible that the resetting element is arranged on the tool part base or the tool jaw of the stripping tool and acts onto the respective partial cutting body from the outside. A pressure spring, which acts on the cutting body from the outside, namely on a front side, which faces away from the cutting parts of the cutting body, is recommended in this case. The resetting element can be a leaf spring, for example.

The resetting element ensures that the partial cutting bodies are displaced into an initial position, in which, for example, the cutting parts or a cutting parts and a holding element bear against one another. A displacement opposite to the resetting force of the resetting element results only during the axial shifting of the two partial cutting bodies during the stripping process following the notching.

Based on the shape of the cutting body or of the tool part base, respectively, it can also be provided according to an embodiment that the cutting body or the partial cutting bodies, respectively, and the tool part base are formed to be conical, based on the corresponding guide surfaces. A first partial cutting body can in particular run in the axial direction towards an adjacent second partial cutting body of the same tool part, and a second partial cutting body can run in the opposite axial direction. According to this embodiment, the partial cutting bodies are, for example, not formed as half cylinders, but, in fact, conically, whereby the diameter thereof runs. This conical design provides for the pivoting of the partial cutting bodies about a longitudinal axis of the tool part. The respective partial cutting body can pivot in particular by 1 degree to 5 degrees, in particular approximately 2.5 degrees. A corresponding movement of the partial cutting bodies and thus also of the assigned cutting parts and/or holding elements is attained thereby while bringing together the tool parts, while the one cutting parts or the several cutting parts, respectively, notch the insulation sheath of the cable. An axial displacement of the cutting body or of the partial cutting bodies in the axial direction, respectively, preferably does not yet take place in this section of the cutting process.

A contact, which is then only still linear, furthermore results during the axial displacement of the conical partial cutting bodies with respect to the likewise conical tool part base because the diameters of the corresponding guide surfaces, based on the same cross sectional plane, then no longer match. A preferred alignment of the partial cutting bodies parallel to one another as well as parallel to the longitudinal axis of the cable to be stripped thus then also takes place simultaneously. In the not yet axially displaced initial position of the partial cutting bodies, the conical shapes and sizes of the tool part base and of the partial cutting bodies, in contrast, preferably correspond to one another in such a way that they bear against one another in their entirety.

It is furthermore proposed that the tool part has a rod-shaped holding element, which is oriented parallel to the axial direction and which passes through at least one passage opening of the tool part in the axial direction, whereby the holding element, based on a circumferential direction of the holding element, at least partially passes through the cutting body and at least partially through at least one of the following tool elements: the cutting parts, the holding element, the additional holding element, the additional cutting parts, a guide element. The tool elements of each tool part, for example the cutting parts thereof, can be replaceably held with the help of the rod-shaped holding element. The holding element passes through the passage openings of one or several tool elements, based on an axial direction, for example initially an additional cutting parts, which is formed for completely severing the cable, and then a cutting parts formed for stripping. A separate holding element is preferably assigned to each partial cutting body. It also be provided, however, that the same holding element passes through the tool elements of both partial cutting bodies. A resilient tensioning of the two partial cutting bodies can then preferably take place, for example, from the outside by a spring element positioned on the holding element. Tool elements are, for example, cutting parts, holding elements, additional holding elements and additional cutting parts according to the preceding description. A tool element can furthermore also be a guide element, which serves the purpose of guiding a cable within the tool part. The guide element can be formed, for example, to align a sector-shaped conductor or to roughly orient it relative to the tool part, respectively, and to prevent an incorrect insertion of the cable. The tool element formed as guide element can be formed, for example, as a guide disk, which has a triangular opening, through which the cable can be inserted. The opening of the guide element is thereby sufficiently large to be able to insert the cable essentially in a straight manner, i.e., parallel to the axial direction. Alternatively, the guide element can also be shiftably mounted on the tool part, in particular shiftably parallel to the axial direction. A guide element can, for example, serve the purpose of roughly orienting a sector-shaped conductor. Such a sector-shaped conductor has, for example, a sector angle of 90 degrees, so that four sector-shaped conductors can be arranged in an externally round cable. Due to a cable stranding, the sector-shaped conductors are twisted in themselves, which optionally results in a support of the insulation sheath, which is thus rotated, on the guide element.

The holding element is preferably inserted into the passage openings on a front surface of the tool part. Beforehand, the tool elements are initially inserted, for example, into grooves formed on the cutting body, which further preferably contact an outer edge of the tool element, which is in particular semi-circular, for example. The holding element can particularly preferably be formed in two pieces comprising a first holding region, which is assigned to the first partial cutting body, and a second holding region, which is assigned to the second partial cutting body. In this case, each partial holding element is preferably inserted into the passage openings from another front side of the tool part. Each tool element can particularly preferably have two passage openings for two separate holding elements. The passage openings are then in particular arranged at opposite positions of the tool element, based on a radial direction. For removing the tool element, for example as part of a replacement, a first one of the two holding elements can then initially be pulled out of the passage opening of the tool element to be replaced, whereby the tool element can then be pivoted out of a current position, namely about a pivot axis, which is formed by the second holding element. According to a further embodiment, the second holding element can then optionally also be shifted in the axial direction until the passage opening assigned to this second holding element is also exposed, and the tool element can then be removed completely from the cutting body. It is advisable that at least one of the holding elements is fastened to the cutting body, preferably in particular permanently. The holding element can be secured to the cutting body, for example, by a tongue and groove connection. Alternatively, other connection forms are also possible, for example latching connections, screw connections or others.

The stripping tool can furthermore also have several receiving regions for receiving the cable, whereby a first receiving region has the pair of tool parts comprising the cutting bodies and whereby a second receiving region has at least one cutting parts for severing the cable or at least one crimping part for crimping the cable with a pressed part, whereby the receiving regions are located next to one another in a cross sectional plane orthogonal to the axial direction. According to this embodiment, the functionality of the proposed stripping tool is additionally supplemented by a cutting parts or a cutting parts pair for severing the cable or by a crimping part or crimping part pair, respectively. Provided that the additional receiving region has a cutting parts for severing the cable, the user can initially perform a shortening of the cable within the second receiving region, in particular prior to the stripping. Provided that the second receiving region has, for example, a crimping part or crimping part pair, the user can displace the cable from the first receiving region into the second receiving region after stripping, in order to then crimp the exposed cable core with a pressed part.

The first receiving region and the second receiving region preferably lie next to one another so that the user can displace the cable from one receiving region into the other transversely to the longitudinal extension of the cable. The longitudinal extension of the cable thereby preferably remains oriented parallel to the axial direction of the tool parts. Provided that the second receiving region has a pair of opposite cutting parts or a pair of opposite crimping part, respectively, a first cutting parts or a first crimping part, respectively, is assigned to the first tool part, and a second cutting parts or a second crimping part, respectively, is assigned to the second tool part.

Based on the stripping tool, it can finally also be provided that at least the first tool jaw can be shifted linearly or can be pivoted about a pivot axis relative to the second tool jaw. The tool jaws can thus generally be brought together in different ways. A group of stripping tools thereby forms the stripping tools comprising tool jaws, which can be shifted linearly to one another. In this case, the stripping tool is formed, for example, so that it has a tool jaw, which is stationary relative to a handle part of the tool body, and a tool jaw, which can be shifted linearly, in contrast, whereby the shiftable tool jaw is displaced towards the stationary tool jaw for the stripping process. The second group of stripping tools includes tools, in the case of which at least one tool jaw, but preferably both tool jaws, is pivotable about a pivot axis. In the case of two tool jaws, which can be displaced towards one another, they can be pivotable about a common pivot axis or also about a respective separate pivot axis.

In addition to the stripping tool, a pair of tool parts for a stripping tool is proposed, whereby the stripping tool is formed according to the above-described type. The stripping tool thus has a pair of tool parts comprising a first tool part and a second tool part, for stripping a cable having a cable core and an insulation sheath, whereby each tool part has a cutting body for receiving a partial region of the cable, whereby the cutting body has at least two cutting parts each comprising a cutting tip for acting on the cable during a stripping process, whereby the cutting tip limits a free space of the cutting body, in which it is provided to receive the cable core, whereby the tool part has a tool part base, which is received on the tool jaw, whereby the cutting body has a first partial cutting body and a second partial cutting body, which can be displaced relative to one another and relative to the tool part base orthogonally to the engagement direction in opposite axial directions, whereby the tool part base and the partial cutting bodies have guide surfaces, which are operatively connected to one another and which provide for the displacement, whereby the guide surfaces extend at a same obtuse angle to the engagement direction, whereby an application of force to the cutting body can be attained solely by a displacement of the tool jaws in the engagement direction, which application of force leads to a displacement of the guide surfaces of the cutting body, and thus of the partial cutting bodies, relative to the guide surfaces of the tool part base with a movement component in the axial direction corresponding to the angle, whereby the first partial cutting body has a first cutting parts or a holding element on a front region facing the second partial cutting body, and wherein the second partial cutting body has a second cutting parts on a front region facing the first partial cutting body, and whereby the cutting body additionally has at least one of the following tool elements: an additional holding element arranged on the first partial cutting body, an additional cutting parts arranged on the second partial cutting body.

The pair of tool parts is thus designed in such a way that it can fulfill the function of the above-described stripping tool when being received in a corresponding stripping tool. This design results in the advantages and features, which have been described above with regard to the stripping tool. The features of the stripping tool, which relate to the formation of the tool parts, also apply accordingly here for the proposed pair of tool parts.

A tool element for the releasable connection to a stripping tool is furthermore proposed, the tool part of which has a rod-shaped holding element for at least one tool element. The tool element is selected from the group of: a cutting parts, a holding element, an additional holding element, an additional cutting parts, a guide element; whereby the tool element provides at least one circumferential partial section of the passage opening. The proposed tool element is thus formed in such a way that it can be reversibly fastened to the tool part by a corresponding, above-described rod-shaped holding element of the stripping tool. For this purpose, the tool element has at least one partial region of a circumferential section of a passage opening, which can then optionally be completed by a corresponding circumferential partial section of a correspondingly formed cutting body. The passage opening is formed to receive the holding element parallel to the axial direction, so that several tool elements of this type with corresponding passage openings can also be received or held, respectively, in a row by the holding element. Tool elements are, for example, cutting parts, holding elements, additional holding elements and additional cutting parts according to the preceding description. A tool element can furthermore also be a guide element, which serves the purpose of guiding a cable within the tool part. The guide element can be formed, for example, to align a sector-shaped conductor or to roughly orient it relative to the tool part, respectively, and thus prevent an incorrect insertion of the cable. The tool element formed as guide element can be formed, for example, as a guide disk, which has a triangular opening, through which the cable can be inserted. The opening of the guide element is thereby sufficiently large to be able to insert the cable essentially in a straight manner, i.e., parallel to the axial direction. Alternatively, the guide element can also be shiftably mounted on the tool part, in particular shiftably parallel to the axial direction. A guide element can, for example, serve the purpose of roughly orienting a sector-shaped conductor. Such a sector-shaped conductor has, for example, a sector angle of 90 degrees, so that four sector-shaped conductors can be arranged in an externally round cable. Due to a cable stranding, the sector-shaped conductors are twisted in themselves, which optionally results in a support of the insulation sheath, which is thus rotated, on the guide element.

According to one embodiment, the tool element can furthermore have an in particular semi-circular design, whereby an edge region of the tool element preferably has an axial thickness, which can be inserted, for example, into a correspondingly wide groove of a cutting body. The tool element is thus held in the cutting body by a tongue and groove connection on the one hand and is secured by the holding element on the other hand. The tool element held in this way can be removed from the tool part, for example, in that the user pulls the rod-shaped holding element out of the passage opening of the tool element in the axial direction, whereupon the user can then remove, in particular pivot out the tool element from the cutting body when the tool parts are open, i.e., spaced apart from one another. Alternatively, the holding element could also be capable of being displaced radially to the outside against a spring force. It would not be required thereby to pull out the holding element, it would rather only need to still be pushed slightly to the outside in order to be able to remove the tool element.

Finally, a method for stripping a cable having a cable core and an insulation sheath is proposed, whereby the method includes the following method steps:
arranging the cable between two opposite cutting bodies, which each have at least two cutting parts, of a first tool part and of a second tool part;
bringing together the two tool parts in an engagement direction;
cutting an axial partial section of the insulation sheath of the cable by using the cutting parts of the tool parts;
displacing a first partial cutting body and a second partial cutting body of the cutting body relative to one another and relative to a tool part base of the tool part in opposite axial directions, which are oriented orthogonally to the engagement direction, whereby guide surfaces, which are operatively connected to one another and which extend at a same obtuse angle to the engagement direction, of the tool part base and of the partial cutting bodies provide for the displacement of the partial cutting bodies, whereby an application of force to the cutting body takes place solely by a displacement of the tool jaws in the engagement direction, which application of force leads to a displacement of the guide surfaces of the partial cutting bodies relative to the guide surfaces of the tool part base with a movement component in the axial direction corresponding to the angle;
separating a first cutting parts or holding element arranged on a front region of the first partial cutting body facing the second partial cutting body from a second cutting parts arranged on a front region of the second partial cutting body facing the first partial cutting body;
When separating the partial cutting bodies, simultaneously also displacing at least one of the following tool elements: an additional holding element arranged on the first partial cutting body, an additional cutting parts arranged on the second partial cutting body;
stripping an axial partial section of the cable by shifting the insulation sheath relative to the cable core during the displacement of the partial cutting bodies relative to the tool part base.

The proposed method is part of an application of the above-proposed stripping tool in several steps, whereby one of the steps relates to a time section, during which the user brings together the tool jaws or tool parts, respectively, to the extent that at least partial regions of the opposite cutting parts contact one another. A second method step comprises a time section after the contacting of the opposite cutting parts, whereby an axial displacement of the partial cutting bodies of the tool parts is triggered. During the separation and the axial displacement of the partial cutting bodies relative to one another, an axial (co-) displacement of at least one tool element, which is additionally present on one of the partial cutting bodies, also takes place simultaneously, in addition to the separation of the cutting parts, which preferably contact one another on the front surfaces of the adjacent partial cutting bodies, which tool element is an additional holding element arranged on the first partial cutting body or an additional cutting parts arranged on the second partial cutting body. According to a further embodiment, an additional holding element on the first partial cutting body as well as an additional cutting parts on the second partial cutting body can also be displaced.

According to the proposed method, the opposite tool parts of the stripping tool are initially displaced towards one another for cutting the insulation sheath of the cable. The tool parts are thereby moved until the cutting tips of the opposite cutting parts or at least partial regions thereof come into contact with one another or at least approximately come into contact with one another. For example, a self-locking of the cutting parts takes place thereby, whereby only the cutting of the insulation sheath takes place, but not yet a relevant axial shifting of the cutting parts. Alternatively to a force-controlled inhibition of the axial shifting, however, a positive control of the axial shifting can also be applied. Provided that the first partial cutting body additionally to a cutting parts also has an additional holding element, the latter can serve the purpose of slightly applying a force to the insulation sheath, in particular to squeeze it, and to thus hold the cable in position. In the case of cables with a plurality of individual strands, a bursting of the cable core can also be prevented. The squeezing of the cable can preferably also prevent the pull-out of individual strands of finely stranded conductors, in particular when the cable to be stripped is not particularly long, for example is shorter than 20 cm.

Provided that the second partial cutting body additionally to the cutting parts has an additional cutting parts, the latter likewise effects a notching of the insulation sheath at a different point of the cable. In response to a subsequent axial shifting of the second partial cutting body, however, no stripping of the cable takes place at this point because the additional cutting parts is arranged in a stationary manner relative to the cutting parts of the second partial cutting body, and the cutting parts and the additional cutting parts thus do not displace against one another. The further function of the additional cutting parts will be described later.

After the contacting of the cutting parts of the opposite tool parts, a further step of the process control is triggered, namely in that the user displaces the tool jaws and thus also the tool parts of the stripping tool further towards one another. This results in an elimination of the movement inhibition, in particular optionally a self-locking effect of the cutting parts, or also to the elimination of a positive connection, which prevents the axial displacement, for example preferably due to the forces applied to the tool parts as a whole. The forces, which have opposite effects on the cutting parts, add up to a resulting total force in the axial direction. This then finally effects the axial displacement of the partial cutting bodies relative to the tool part base. The two partial cutting bodies are thus moved away from one another, namely in opposite axial directions, so that the cut end section of the insulation sheath is shifted over a first stripping length relative to the cable core of the cable. The first stripping length defined here thereby identifies that length section of the cable, at which the insulation sheath is pushed away from the cable core. It is irrelevant thereby whether the pushing away took place by the first partial cutting body or the second partial cutting body, only the length of the stripped partial section on the cable core is relevant.

When bringing the tool parts together, at least a partial region of the cutting body or partial cutting body, respectively, is pressed onto at least one guide surface of a wedge structure, which slopes in the axial direction. In response to continued application of force, the partial cutting body is guided downwards along the guide surface extending at an obtuse angle to the engagement direction and is thus simultaneously displaced in the axial direction until an end position is reached. This also applies when the guide surface is not formed to be flat but curved, for example as conically formed guide surface. The end position of the stripping tool is specified by the tool jaws, which are guided on one another or optionally by a resetting element, respectively, the resetting force of which wants to displace the partial cutting bodies back into the initial position. The resetting element can, for example, connect the partial cutting bodies to one another and can displace them towards one another.

According to a further embodiment, it is possible that a resetting element in each case engages with the respective partial cutting body from the outside and seeks to displace it in the direction of the other partial cutting body. The end position is further specified at least by a meeting of the tool parts, in which the cutting parts are arranged. The end position is further specified at least by a meeting of the tool part base of the first tool part and of the tool part base of the second tool part. This end position identifies a completely closed state of the stripping tool or of the opposite tool jaws, respectively.

The displacement of the two preferably takes place by symmetrical displacement movements of the partial cutting bodies relative to the tool part base of the respective tool part. Starting at an interface, forces are exerted on the insulation sheath in two opposite directions, which simplifies the stripping of the cable. By the displacement of the two partial cutting bodies relative to one another, two cutting parts can be displaced relative to one another according to one embodiment. Alternatively, a holding element, for example of the first partial cutting body, and a cutting parts of the second partial cutting body can be separated by the displacement of the two partial cutting bodies.

An additional holding element is furthermore simultaneously also displaced with the first partial cutting body or an additional cutting parts arranged thereon is simultaneously also displaced with the second partial cutting body. Provided that both partial cutting bodies have a cutting parts on their front regions, the method can initially provide, for example, that a first cutting parts arranged on a front region of the first partial cutting body facing the second partial cutting body is separated from a second cutting parts arranged on a front region of the second partial cutting body facing the first partial cutting body. An in particular central and symmetrical separation of the two cutting parts preferably results when displacing the two adjacent partial cutting bodies away from one another. An optionally provided additional holding element of the first partial cutting body is simultaneously furthermore also displaced with the cutting parts of this first partial cutting body. The same is true with regard to the second partial cutting body when the latter, in addition to the cutting parts, has an additional cutting parts. Cutting parts and additional cutting parts are then also displaced at a constant distance and simultaneously relative to the tool part base.

It is furthermore proposed that the stripping of the axial partial section of the cable takes place in two partial steps, which are temporally separated from one another, whereby the user initially shifts the insulation sheath by a first stripping length relative to the cable core during a first partial step by bringing together the tool parts, whereby the user subsequently displaces the cable in the axial direction relative to the tool parts into a second position and whereby the user then shifts the insulation sheath by a second stripping length relative to the cable core in the second position during a second partial step by bringing together the tool parts once again.

As part of the proposed process control, a double shifting of the stripped end piece of the insulation sheath relative to the cable core thus occurs. The second stripping length can thereby reach almost the length of the first stripping length, so that the cable core is exposed once again during the second stripping step by an axial partial section, which can be almost as large as a length of the partial section, which is slid free in the first stripping step. Such a double displacement is attained by a supplementation of the tool elements provided on the respective partial cutting body, for example in that the first partial cutting body has a cutting parts or a holding element as well as an additional holding element. Alternatively or additionally, the second partial cutting body can have a cutting parts as well as an additional cutting parts. It is essential that either the first partial cutting body has an additional holding element or that the second partial cutting body has an additional cutting parts. During the first installation step, a front-side pair of two cutting parts or a front-side pair of a cutting parts and a holding element, respectively, initially serves the purpose of notching the insulation sheath and pushing the same over a first stripping length. After the first stripping step and prior to the second stripping step, the pair of two cutting parts or of a cutting parts and a holding element, respectively, as well as the additionally available additional holding element or the additional cutting parts are then positioned at the stripped partial section of the cable. For this purpose, the user positions the cable between the tool parts so that, for example, the first cutting parts or the holding element of the first partial cutting body, and the additional cutting parts of the second partial cutting body lie within the axial partial section of the cable, which is stripped by the first stripping length, when the front regions of the partial cutting bodies contact one another. Prior to the beginning of the second stripping step, the two partial cutting bodies, which were previously spaced apart from one another, are thus guided on one another again, so that the stripping tool is in an initial position. In response to a renewed actuation of the stripping tool, an application of force to the opposite front regions of the insulation sheath, which face one another and which are exposed, then results by the tool elements, which face the respective front region.

Provided that the first partial cutting body has an additional holding element, the latter supports itself against an exposed front region of the insulation sheath, while the cutting parts of the second partial cutting body acts against the front region of the exposed end piece of the insulation sheath facing away therefrom. In response to the repeated actuation of the stripping tool, the two exposed front regions are then spaced apart from one another even further, namely additionally by the second stripping length.

Even though an additional cutting parts, which is optionally available on the second partial cutting body, notches the insulation sheath during the first stripping step, it does not have any other effect, in particular no tear-off of the end region of the cable notched in this way because the additional cutting parts is displaced together with the cutting parts (because the additional cutting parts is arranged in a stationary manner relative to the cutting parts). After the first stripping process, the user then has to then touch the cable and has to lay it in the stripping tool so that the edge region of the stripped end piece of the cable lies in front of the additional cutting parts, which then subsequently caries out the further displacement of the end section during the second stripping step. This then takes place as part of a further bringing together of the tool parts of the stripping tool.

A possible process control provides that after carrying out the first partial step and prior to carrying out the second partial step, the user positions the cable between the tool parts so that the second cutting parts of the second partial cutting body and the additional holding part of the first partial cutting body lie within an axial partial section of the cable, which is stripped by the first stripping length, when the front regions of the partial cutting bodies contact one another. According to this design, the user has to lay the cable within the stripping tool after carrying out the first stripping step so that the additional holding element of the first partial cutting body and the cutting parts of the second partial cutting body lie within the already stripped partial section of the cable. In response to a renewed actuation of the stripping tool as part of a second stripping step, a further shifting of the already stripped end piece of the insulation sheath then occurs by the second cutting parts of the second partial cutting body, while the additional holding element of the first partial cutting body supports itself against the front region of the residual cable located opposite the already shifted end piece.

A further possible process control can provide that the additional cutting parts completely severs the cable when reaching a completely brought-together end position of the tool jaws. In this case, the additional cutting parts arranged on the second partial cutting body is configured to completely sever the cable, i.e., to shorten the cable. The severing of the cable takes place simultaneously with the stripping of the cable, in a remote axial end region of the cable. Due to this design, it is not required that the user initially separately carries out a stripping of the cable and subsequently a shortening of the cable, or vice versa. On the contrary, he has to actuate the stripping tool only one time, whereby the tool jaws are brought together only one time. This process control does not depend on a “lengthened” stripping as part of two consecutive stripping steps but rather on a simultaneous stripping and severing of the cable. It is not ruled out, however, that an additional cutting parts can be provided, which carries out a stripping as part of a second stripping step. In this case, the additional cutting parts, which is formed for completely severing the cable, is preferably positioned further on the outside on the end region of the cable, which was already pushed away in the first stripping step, so that this additional cutting parts preferably no longer has no contact whatsoever with the circumferential region of the cable during the second stripping step and thus does not cut through the cable once again at a different point.

With reference to all of the above-described process controls, it is finally proposed that the displacement of the partial cutting body relative to the tool part base takes place along at least one guide surface of a wedge structure sloping in the axial direction. Each tool part body is thereby displaced in the respective assigned axial direction on one or several of these guide surfaces, which are separately assigned to this tool part body. The guide surfaces, which slope in opposite axial directions starting at a wedge peak, are preferably arranged and formed symmetrically to one another. A wedge angle of the wedge structure thereby specifies the angle of the guide surfaces to the axial direction of the tool part. The wedge angle, i.e., the gradient of the guide surfaces, is preferably between 10 degrees and 20 degrees, preferably approx. 15 degrees. The displacement of the respective partial cutting body can take place on several parallel guide surfaces, for example narrow guide strips, which are arranged parallel to one another. Based on the axial direction of the tool part base, the wedge peak of the wedge structure is arranged in an axial position, which, in the initial position, is assigned to the axial position of the cutting tip, preferably corresponds approximately to the axial position of the cutting tip of the cutting parts. This is then preferably simultaneously also that axial position, in which the notching of the insulation sheath of the cable takes place in the initial position of the stripping tool. As soon as the insulation sheath is cut through completely or almost completely and the cutting tips of the opposite tool parts thus meet or at least further approach one another, the system of the two opposite cutting parts can be considered to be a body, on which, based on the radial direction, opposing forces act, which then result in a total force in the axial direction and displace the partial cutting bodies including the cutting parts or holding elements thereof, respectively, in opposite axial directions, whereby the partial cutting bodies are each shifted on the guide surface or guide surfaces of the wedge structure, respectively, which is assigned to them individually. This then finally effects the stripping of the cable.

In practice, the displacement of the partial cutting bodies relative to the tool part base preferably takes place along individual webs, which are aligned in the axial direction. A guidance of the partial cutting bodies on the complete surface of the wedge structure is also possible, even though such an embodiment is not preferred, however. The web-shaped guidance in a radially outer region of the wedge structure or of the tool part base, respectively, provides for a direct dissipation of the forces linearly downwards in the stripping tool, i.e., into the assigned tool jaw, without initially having to dissipate the forces in a curve onto a lower region of the wedge structure facing the tool jaws.

### BRIEF DESCRIPTION OF THE DRAWINGS

The disclosure is described below on the basis of the enclosed drawings, which only represent exemplary embodiments. A component part, which is only described based on one of the exemplary embodiments and which is not replaced with another component part in the case of a further exemplary embodiment due to the special feature emphasized there, is thus also described as at least possibly available component part for the further exemplary embodiment. In the drawings:

FIG. 1 shows a stripping tool in perspective illustration comprising a pair of tool parts arranged in tool jaws, relating to a first embodiment;

FIG. 2 shows a working head of the stripping tool with an exploded illustration of the pair of tool parts according to FIG. 1;

FIG. 3 shows a perspective illustration of the tool parts, which are guided on one another, in an initial position;

FIG. 4 shows a cross section of the tool parts according to the plane IV in FIG. 3;

FIG. 5 shows a longitudinal section view according to the plane V in FIG. 2;

FIG. 6 shows a perspective illustration of the tool jaws in a position separated from one another;

FIG. 7 shows a longitudinal section view according to the plane VII in FIG. 6;

FIG. 8 shows a longitudinal section view through the tool jaws, which are guided on one another, in the initial position;

FIG. 9 shows a perspective illustration of the tool jaws in an end position brought together after ending a first stripping process;

FIG. 10 shows a perspective illustration of the tool jaws according to FIG. 9 in a position separated from one another;

FIG. 11 shows a longitudinal section view according to the plane XI in FIG. 9;

FIG. 12 shows a longitudinal section view through the tool jaws, which are separated from one another, prior to the beginning of a second stripping process;

FIG. 13 shows a longitudinal section view through the tool jaws, which are guided on one another, after ending the second stripping process;

FIG. 14 shows a longitudinal section view through a pair of tool parts according to a further embodiment during a first stripping process;

FIG. 15 shows a longitudinal section view through the pair of tool parts of FIG. 14 after ending the first stripping process;

FIG. 16 shows a perspective illustration of the pair of tool parts according to Figs. FIGS. 14 and 15 prior to the beginning of a second stripping process by using an additional holding element;

FIG. 17 shows a longitudinal section view according to the plane XVII in FIG. 16;

FIG. 18 shows a perspective top view onto one of the tool parts after ending the second stripping process, according to a further embodiment;

FIG. 19 shows a longitudinal section view according to the plane XIX in FIG. 18;

FIG. 20 shows a cutting parts according to a first embodiment;

FIG. 21 shows the cutting parts according to FIG. 20 in a perspective illustration;

FIG. 22 shows a cutting parts according to a second embodiment;

FIG. 23 shows the cutting parts according to FIG. 22 in a perspective illustration;

FIG. 24 shows a pair of tool parts according to a further embodiment prior to the beginning of a stripping process, in perspective illustration;

FIG. 24a an enlarged view of the section XXIVa in FIG. 24;

FIG. 25 shows a perspective top view onto one of the tool parts according to FIG. 24;

FIG. 26 shows a perspective top view onto one of the tool parts according to FIG. 25 and further showing a cut cable in perspective;

FIG. 27 shows a longitudinal section view through the pair of tool parts and the cut cable of FIG. 24 according to the plane XXVII;

FIG. 28 shows a perspective top view of the pair of tool parts and the cut cable according to FIG. 24 after ending the stripping process;

FIG. 29 shows a perspective top view onto one of the tool parts and the cut cable according to FIG. 28;

FIG. 30 shows a longitudinal section view through the tool parts and the cut cable according to the plane XXX in FIG. 28;

FIG. 31 shows a perspective view of a working head of a stripping tool including a pair of tool parts arranged in tool jaws, relating to a further embodiment including two receiving regions for a cable;

FIG. 32 shows an exploded perspective view of the pair of tool parts according to FIG. 31;

FIG. 33 shows a perspective view of one of the tool parts and a cable in an initial position;

FIG. 34 shows a perspective view of the tool part according to FIG. 33 and the cable in an end position after carrying out a stripping process;

FIG. 35 shows a perspective view of a pair of tool parts according to a further embodiment including two separate receiving regions for a cable;

FIG. 36 shows an elevation view of the pair of tool parts according to FIG. 35, viewed in the axial direction;

FIG. 37 shows a perspective view onto one of the tool parts according to FIG. 35;

FIG. 38 shows a perspective view of a pair of tool parts according to a further embodiment after ending a stripping process;

FIG. 39 shows a perspective top view onto one of the tool parts according to FIG. 38;

FIG. 40 shows a an end elevation view of a cutting parts of a tool part according to Figs. FIGS. 38 and 39;

FIG. 41 shows a perspective view of a pair of tool parts according to a further embodiment after carrying out a stripping process;

FIG. 42 shows a perspective top view onto one of the tool parts according to FIG. 41;

FIG. 43 shows a longitudinal section view of a further embodiment of a pair of tool parts in an end position of the tool parts, which is brought together after ending a first stripping process;

FIG. 44 shows a longitudinal section view of the pair of tool parts according to FIG. 43 after ending a second stripping process;

FIG. 45 shows a perspective view of a pair of tool parts according to a further embodiment and a cable to be stripped prior to carrying out a first stripping process;

FIG. 46 shows a perspective view of one of the tool parts according to FIG. 45 and the cable after ending the first stripping process;

FIG. 47 shows a perspective view of a pair of tool parts according to a further embodiment for stripping sector-shaped conductors;

FIG. 48 shows a perspective view of one of the tool parts according to FIG. 47 and a cable to be stripped during a first stripping process; and

FIG. 49 shows the tool part according to FIG. 48 and a cable to be stripped according to a further perspective view;

FIG. 50 shows a perspective illustration of a tool part according to a further possible embodiment;

FIG. 51 shows a perspective illustration of a journal for the tool part illustrated in FIG. 50;

FIG. 52 shows an enlarged perspective view of the region LII in FIG. 50;

FIG. 53 shows a cross-section view, shown in perspective, according to the line LIII-LIII in FIG. 52;

FIG. 54 a view of two pairs of cutting parts in a further embodiment;

FIG. 55 a sectional view substantially corresponding to FIG. 14, concerning an arrangement with cutting parts according to FIG. 54;

FIG. 56 a representation corresponding to FIG. 55, after completion of the first stripping process;

FIG. 57 a perspective sectional view of an embodiment with a reversible fastening for the cutting parts;

FIG. 58 a representation corresponding to FIG. 57 after the fastening has been removed;

FIG. 59 the view according to arrow LIX in FIG. 58.

### DESCRIPTION OF THE EMBODIMENTS

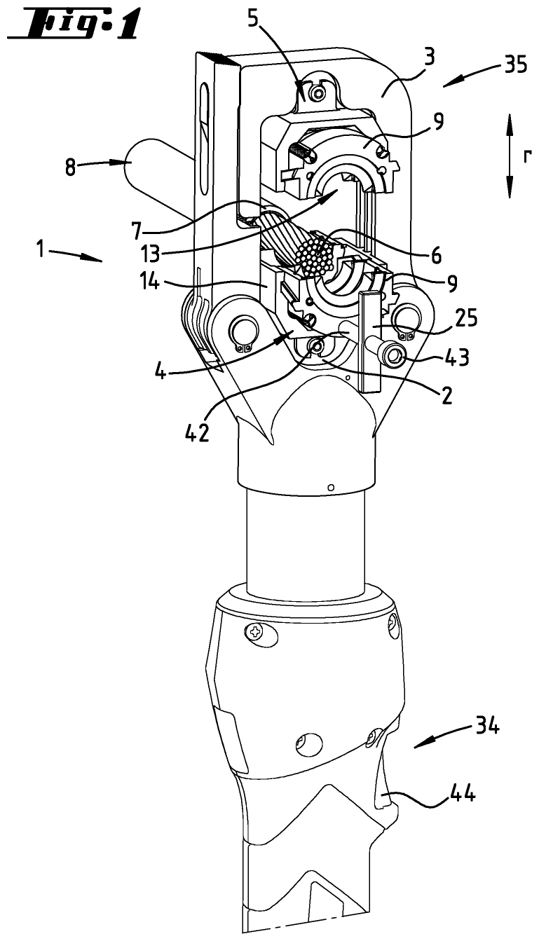

What is illustrated and described, initially with reference to FIG. 1, is a stripping tool 1, which is formed here in the shape of a rod-like drive device part comprising a handle region 34 and a working head 35. Alternatively, the stripping tool 1 can, for example, also be formed with an essentially gun-like drive device part.

Drive device parts of this type or stripping tools 1, respectively, are known, for example, from the WO 2008/138987 A2 (U.S. Pat. No. 8,056,473 B2) or also from the WO 2003/084719 A2 (U.S. Pat. No. 7,254,982 B2). The stripping tool 1 can alternatively have an electromotive spindle drive. Such a hand tool is known, for example, from the WO 2014/009363 A1 (U.S. Pat. No. 10,468,847 B2). The content of these WO publications or US publications, respectively, is hereby included in its entirety into the disclosure of solutions described herein, also for the purpose of including features of these WO publications or US publications, respectively, in claims of the present documents.

Two tool jaws 2, 3, which can be moved linearly towards one another, are arranged in the working head 35, whereby a movable first tool jaw 2 can preferably be linearly displaced onto a preferably stationary second tool jaw 3 during the operation of the stripping tool 1. The drive preferably takes place electro-hydraulically, for the purpose of which an accumulator can further for example be provided on the end side of the handle region 34, which accumulator can further also serve the purpose of electrically supplying, for example, a hydraulic medium pump and a control unit.

The tool jaws 2, 3 are carriers of a pair of tool parts 4, 5, which are preferably held in a replaceable manner in the tool jaws 2, 3, having a first tool part 4 and a second tool part 5. A screwing or latching fixation of the tool parts 4, 5 can in particular be provided in the assigned tool jaws 2, 3, in particular for the simplified removal of the tool parts 4, 5 from the tool jaws 2, 3 or for replacing the tool parts 4, 5. As shown, the tool part 4 forms a lower tool part, and the tool part 5 forms an upper tool part.

The tool parts 4, 5 can, and as also preferred, be be formed substantially identically, so that a firm assignment of the tool part 4, 5 to a certain tool jaw 2, 3 is not mandatorily specified in the case of replaceable tool parts 4, 5.

The tool parts 4, 5 of the embodiments illustrated in the following figures are formed for stripping a cable 8. In the usual way, such a cable 8 has a cable core 6 preferably including a plurality of strands and an insulation sheath 7 surrounding the cable core 6. In order to be able to establish an electrically conductive connection of the cable 8, the cable core 6 needs to initially be exposed in the corresponding section of the cable 8 by removing an axial section of the insulation sheath 7.

The tool parts 4, 5 are designed for an ultimately complete removal of an end-side insulation section of the insulation sheath 7 by notching and/or cutting through the insulation sheath 7 at a specified position of the cable 8, which is enclosed by the tool parts 4, 5.

The pair of tool parts 4, 5 initially has a receiving region 38, which is formed by two cutting bodies 9, in a cross section (see FIG. 4) viewed transversely to a longitudinal extension of a cable 8, which is guided between the tool parts 4, 5 for stripping. Each cutting body 9 belongs to the certain tool part 4, 5 of the pair of tool parts 4, 5. Each cutting body 9 surrounds the inserted cable 8, for example essentially semi-circularly. The two cutting bodies 9 of the tool parts 4, 5 accordingly preferably supplement one another to form a receptacle, which is essentially circular cylindrical as a whole, comprising a free space 13 for the cable 8, in the brought-together state of the tool parts 4, 5.

An axial end stop 25, which limits a length of the cable 8 protruding from the stripping tool 1 on the end side, is coupled to one of the tool parts 4, 5, here for example the lower tool part 4. The user of the stripping tool 1 can determine therewith, how long in particular the stripped end section of the cable 8 is to be by adjustment of the end stop 25 as described herein.

As can further be seen, in particular also starting at FIG. 2, each tool part 4, 5 has a cutting body 9 and a tool part base 14 receiving the cutting body 9. The cutting body 9 includes two partial cutting bodies 17, 18, which can be displaced relative to one another in the axial direction a within the tool part base 14. Each partial cutting body 17, 18 has a generally semi-cylindrical shape which defines a channel. When the partial cutting bodies 17, 18 of the lower tool part 4 are engaged against the respective partial cutting bodies 17, 18 of the upper tool part 5, a cylindrical unit is formed with a receiving region therethrough which is provided to receive the cable 8. Each partial cutting body 17, 18 has at least one cutting part 10, 11, which is arranged on a front region 19 in a receptacle 49 formed in the channel of each partial cutting body 17, 18.

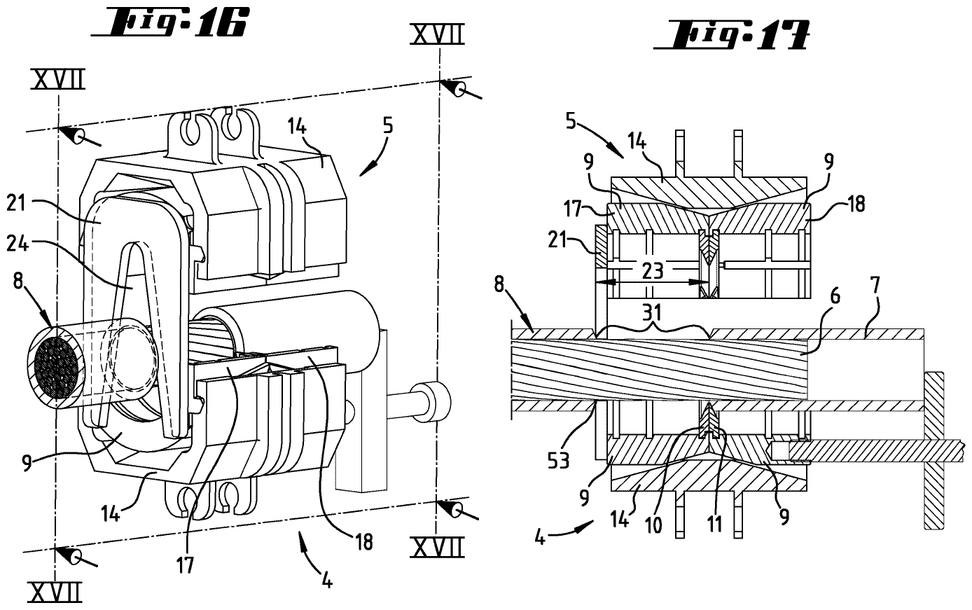

Examples of the cutting parts 10, 11 are shown in FIGS. 20-23 and are described herein. In an embodiment, the receptacles 49 are formed as grooves. Each cutting part 10, 11 includes a cutting tip 12. Based on the cross-section (transversely to the axial direction a), the cutting tip 12 is likewise formed with a semi-circular shape and limits the receiving region through the engaged partial cutting bodies 17, 18 to define a radially inner free space 13 which receives the cable core 6 of the cable 8. The inner free space 13 has a diameter, which corresponds to the diameter of the cable core 6 or which is slightly larger, for example larger by 1 mm or 2 mm or fractions thereof.

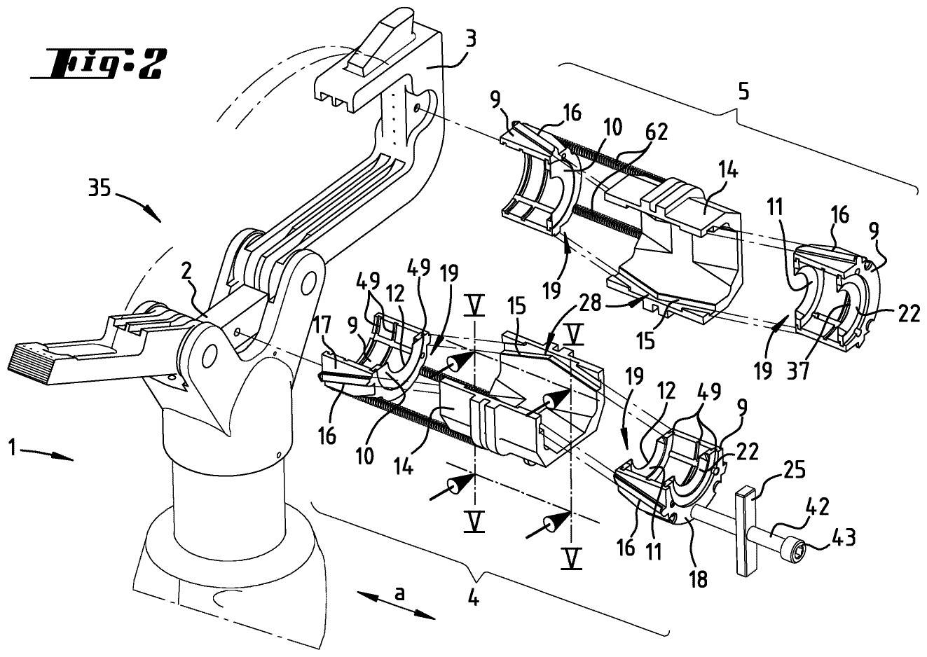

The initial position of the tool parts 4, 5 is illustrated in FIG. 3. In this initial position, the cutting part 10 on the partial cutting body 17 contacts the cutting part 11 on the partial cutting body 18 in each tool part 4, 5 at the front regions 19 of the partial cutting bodies 17, 18 prior to carrying out a stripping process. Furthermore each cutting part 10, 11 can be formed in one piece with and also preferably of the same material as the respective tool parts 4, 5.

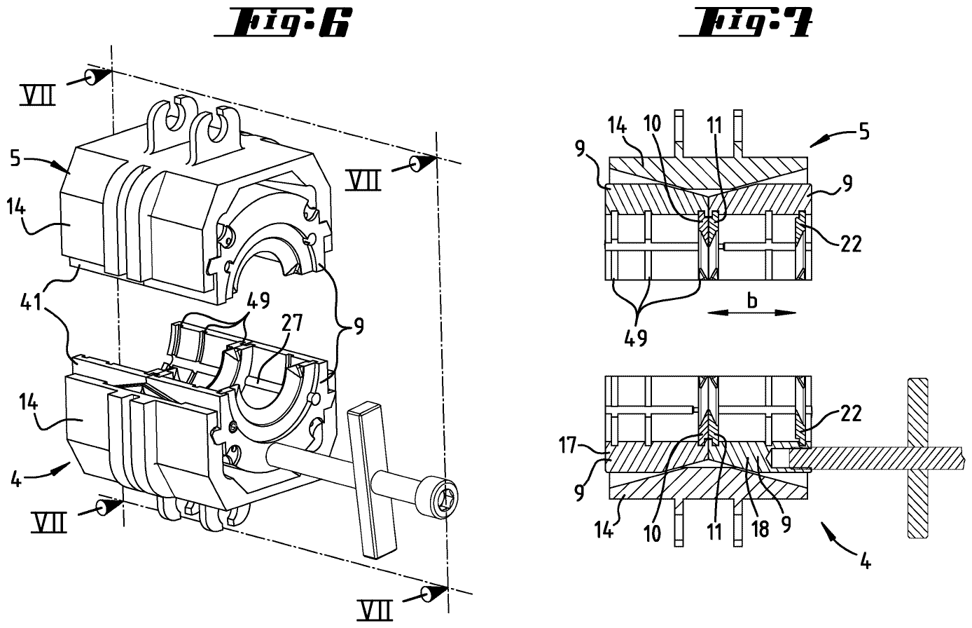

In this position, the cutting tips 12 of the cutting parts 10 of the partial cutting bodies 17 point radially inwards and therefore towards one another and leaves the inner free space 13, and the cutting tips 12 of the cutting parts 11 of the partial cutting bodies 18 point radially inwards and therefore towards one another and leaves the inner free space 13. Even though the cutting part 10 or 11, respectively (as illustrated further in FIG. 8) can thus accordingly notch or completely sever the insulation sheath 7, all the way into a depth, in which the cutting part 10 or 11, respectively, move against the circumference of the cable core 6, but preferably without damaging the cable core 6 or individual strands running therein, respectively.

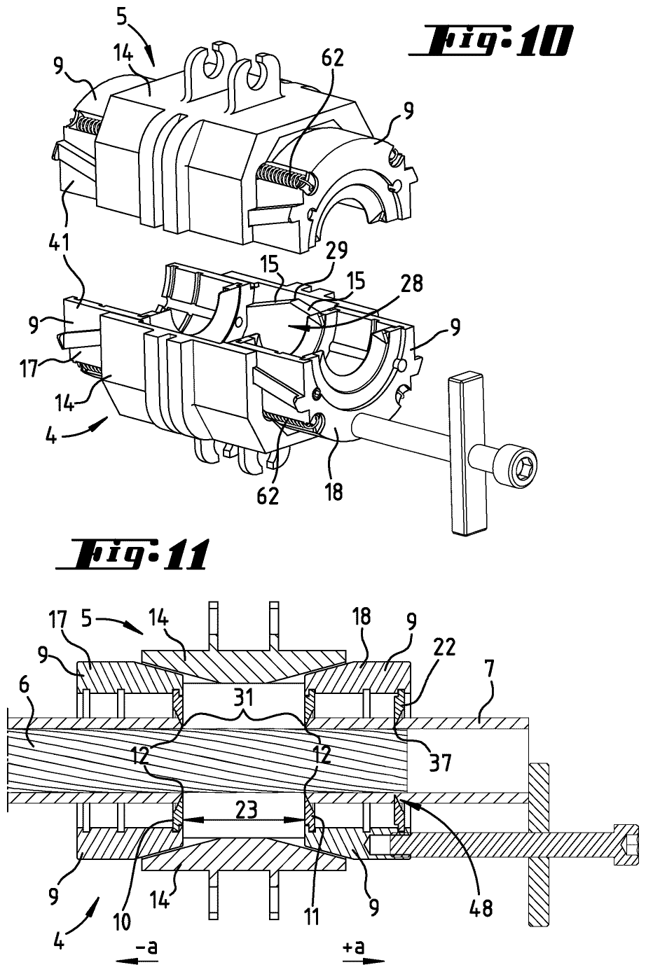

As furthermore follows from FIG. 2, each second partial cutting body 18 in the illustrated exemplary embodiment has, in addition to the cutting part 11, an additional cutting part 22, which is spaced apart from the cutting part 11 in the axial direction a. The additional cutting part 22 likewise has a cutting tip 37 having a semi-circular shape, which likewise leaves the radially inner free space 13, the diameter of which corresponds to the diameter of the cutting part 11. The function of the additional cutting part 22 will be described in more detail later, in particular with reference to FIGS. 12 and 13. Furthermore there is a distance b in an axial direction x between the first cutting parts (10) or the holding element (20) (see, for example, FIGS. 43 and 44) of the first partial cutting body (17) and the additional cutting parts (22) of the second partial cutting body (18) (see FIG. 7).

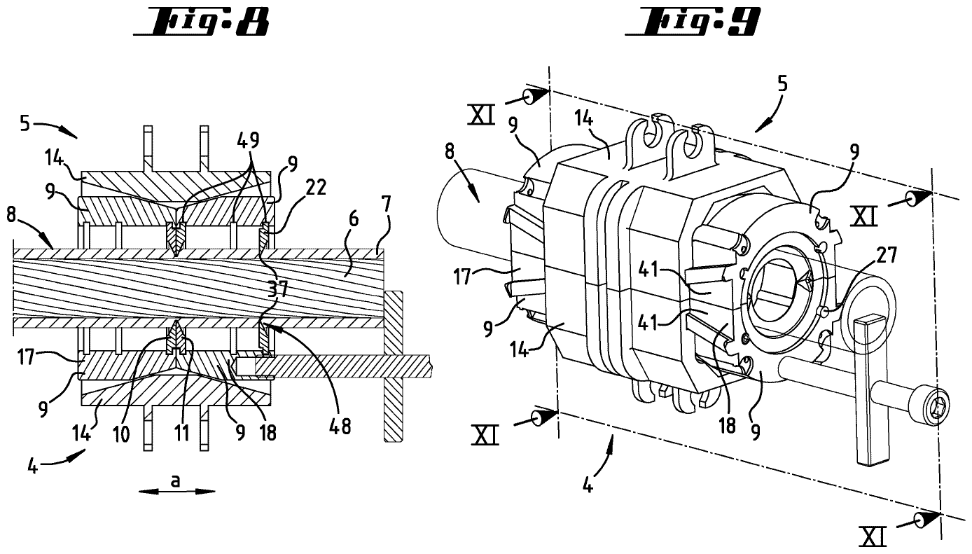

As can be seen in particular from a comparison of FIGS. 3 and 6, which illustrate the initial position of the tool parts 4, 5 (after a bringing-together effected all the way to a contact of the tool parts 4, 5), with FIGS. 9 and 10, which illustrate the brought-together end position of the tool parts 4, 5, an edge region 41 of the respective partial cutting body 17, 18, based on the circumferential direction of the respective tool part 4, 5, protrudes beyond the edge of the tool part base 14. When bringing together the tool parts 4, 5, the corresponding edge regions 41 of the opposite tool parts 4, 5 abut against one another and are brought behind the contour of the tool part base 14 by the actuating force of the user applied from the outside—as can be seen, for example, when comparing FIGS. 6 and 10. If the partial cutting bodies 17, 18 can also be pivoted relative to the tool part base 14, the cutting bodies 17, 18 are also displaced in the circumferential direction.

Based on the axial direction a, the partial cutting bodies 17, 18 are at least partially slid out of the brought-together tool jaws 2, 3 to the outside—as can be seen in FIG. 9 in the brought-together end position. Due to the fact that the cutting parts 10, 11 are also displaced, this simultaneously leads to the stripping of an axial partial section 31 of the cable 8. A corresponding end section of the separated insulation sheath 7 is thus pushed to the outside in the axial direction a, so that the user can optionally grip it in an advantageous manner and can pull it off the cable core 6.

Based on the illustration of the figures, the edge regions 41 of the cutting bodies 9 or partial cutting bodies 17, 18, respectively, of the opposite tool parts 4, 5 have horizontal contact surfaces, which, in the case of the partial cutting bodies 17, 18, which are preferably formed in a dome-like manner as a whole, are formed on the surfaces, which in each case face the opposite partial cutting bodies 17, 18 in the engagement direction r and which extend in the axial direction a. These contact surfaces come to bear against one another after the completion of the notching into the insulation sheath 7, for instance in the situation according to FIG. 3 or 8, respectively, and are then displaced jointly in the axial direction a, namely into the position according to FIGS. 9 to 11, for example, without a relative shift resulting as a rule between the edge region 41, thus with the two opposite partial cutting bodies 17, 18 together.

The tool part base 14 provides a guidance for the displacement movement of the partial cutting bodies 17, 18 in the axial direction-a or +a, respectively. The partial cutting bodies 17, 18 can accordingly be displaced in an axial direction a, namely opposite axial directions −a and −+a relative to the tool part base 14, and orthogonally to the engagement direction r. As illustrated in FIGS. 9 to 11, the first partial cutting body 17, starting at the initial position according to FIG. 3, can be displaced in an axial direction-a, while the second partial cutting body 18 can be displaced in the accordingly opposite direction +a. For this purpose, the partial cutting bodies 17, 18 are mounted on the tool part base 14 in a linearly shiftable manner. Alternatively, however, it would also be possible to support the partial cutting bodies 17, 18 directly on the assigned tool jaws 2, 3, even if this embodiments is not preferred.

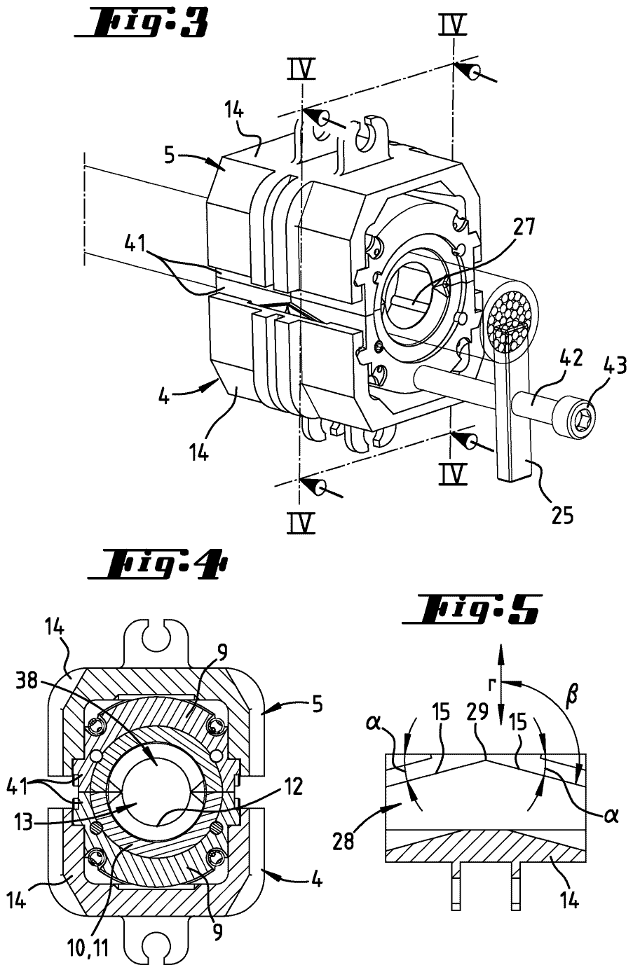

As can furthermore in particular be seen in FIGS. 2 and 5, the tool part base 14 has preferably on opposite sides of the tool part base 14 a wedge structure 28 comprising a wedge peak 29 and sloping guide surfaces 15 extending from the wedge peak 29, which extend at a wedge angle α (see FIG. 5) relative to the axial direction a. The wedge angle α is preferably between 10 degrees and 20 degrees, in particular approx. 15 degrees. This results in an obtuse angle β of preferably between 100 degrees and 110 degrees, in particular 105 degrees between each guide surface 15, 16 and the direction of engagement r (see FIG. 5). The guide surfaces 15 of the tool part base 14 are formed here as web-like partial regions of the tool part base 14. Corresponding guide surfaces 16 are formed on each partial cutting body 17, 18 and are supported and guided on these web-like guide surfaces 15. In practice, a guidance thus only takes place at individual webs, which are aligned in the axial direction a. A guidance of the partial cutting bodies 17, 18 on the guide surface 15, which extends over the entire cross section of the tool part base 14, is generally also possible, however, even though such an embodiment is not preferred.

The web-shaped guide (referred as a guide surface 15) in the radially outer region of the wedge structure 28 or of the tool part base 14, respectively, which is preferred here, provides for a direct dissipation of the forces linearly downwards, i.e. into the assigned tool jaw 2, 3, without having to initially dissipate the forces in a curve onto a lower region of the wedge structure 28 facing the tool jaws 2, 3. In the case of the exemplary embodiment illustrated here, the guide surfaces 15 of the tool part base 14 are arranged mirror-symmetrically to a cross-sectional plane of the wedge structure 28, in which the wedge peak 29 is formed.

As shown, for example, in FIGS. 2 and 3, the second partial cutting body 18 of the lower tool part 4 has the axial end stop 25, which defines a length of the cable 8, which is inserted into the stripping tool 1. The axial end stop 25 is mounted here, for example, on a guide rod 42 extending from the second partial cutting body 18 of the lower tool part 4. The guide rod 42 passes through the end stop 25, whereby the end stop 25 can be fixed to the guide rod 42 in a defined position by a lock 43, here for example by a screw. Embodiments are furthermore conceivable, in the case of which the end stop 25 is not part of the cutting body 9 but, for example, part of a tool jaw 2, 3. The end stop 25, in turn, is preferably shiftable in this case, so as not to obstruct the axial movement of the end section of the insulation sheath 7, which was slid away.

The mode of operation of the stripping tool 1 according to the embodiment illustrated in FIGS. 1 to 13 will be described in more detail below.

The user of the stripping tool 1 initially places the cable 8, which is to be stripped, between the tool jaws 2, 3 of the working head 35. The user thereby preferably places the cable 8 with a free end region against the end stop 25. The user then actuates the stripping tool 1 via an actuating element 44, which is arranged on the handle region 34. A hydraulic medium pump of the stripping tool 1, for example, is started via the actuating element 44. A displacement of a ram, which is not illustrated in more detail and which acts on the displaceable first tool jaw 2, can be effected within the stripping tool 1. The tool jaws 2, 3 are brought together in any case and the partial cutting bodies 17, 18 are displaced in the axial direction a. An axial end section of the insulation sheath 7 is extended thereby with the second partial cutting body by using the cutting parts 11 from the tool parts 4, 5.

In a first operating step, the user initially brings together the opposite tool jaws 2, 3 into the initial position illustrated in FIG. 3 or 8, respectively. In this initial position, the contact surfaces located on the edge regions 41 of the opposite cutting bodies 9 contact one another. As can be seen in the illustration of the longitudinal section according to FIG. 8, the cutting tips 12 of the cutting parts 10, 11 of the respective cutting body 9 already engage with the insulation sheath 7. The cutting tips 12 can thereby either completely sever the insulation sheath 7 thereby or at least carve into it. The cutting tips 37 of the additional cutting parts 22 of the opposite cutting bodies 9 also engage with the insulation sheath 7 in the same way.

As long as the cutting parts 10, 11 have contact only with the insulation sheath 7, but do not mutually contact one another, frictional forces act on the cutting parts 10, 11 lead to a movement inhibition of the cutting parts 10, 11 in the axial direction a. When the user displaces the tool jaws 2, 3, and thus also the tool parts 4, 5, further towards one another, this preferably results in an elimination of the movement inhibition due to the forces, which are then applied as a whole to the tool parts 4, 5, in particular optionally in a self-locking effect of the cutting parts 10, 11. As soon as at least partial regions of the opposite cutting part 10 or 11, respectively, or the cutting tips 12 thereof contact one another, the cutting part 10 or 11, respectively, of the opposite tool parts 4, 5 can be considered to be a common body. The forces, which have opposite effects on the cutting parts 10, 11, which the user exerts in response to a further bringing-together of the tool jaws 2, 3, then add up to a resulting total force in the axial direction a. The axial displacement of the partial cutting bodies 17, 18 thus takes place, whereby the first partial cutting body 17 is displaced in an axial direction-a, and the second partial cutting body 18 is displaced in an opposite axial direction +a. Due to the axial displacement of the partial cutting bodies 17, 18, the insulation sheath 7 is preferably torn first and a torn-off end region of the insulation sheath 7 is shifted relative to the cable core 6.

The displacement of the two partial cutting bodies 17, 18 relative to the tool part base 14 takes place along the sloping guide surfaces 15 of the tool part base 14, whereby the likewise web-shaped guide surfaces 16 of the partial cutting bodies 17, 18 glide along the respective corresponding guide surface 15 of the tool part base 14. The cutting parts 10, 11 of the partial cutting bodies 17, 18 separate for the axial displacement movement in the region of the wedge peak 29 of the wedge structure 28 of the tool part base 14. In the initial position of the tool jaws 2, 3 according to the given embodiment, the cutting tips 12 are, for this purpose, preferably located above the wedge peak 29, i.e., the wedge peak 29 and the cutting tips 12 are preferably positioned in the same cross-sectional plane of the tool parts 4, 5.

The axial displacement of the partial cutting bodies 17, 18 creates a stripped axial partial section 31 of the cable 8 (see, for example, FIG. 11). The separated end region of the insulation sheath 7, which was shifted relative to the cable core 6, furthermore abuts against the end stop 25, which is arranged in a stationary manner on the second partial cutting body 18 and which was thus likewise shifted relative to the tool part base 14.

Provided that the user of the stripping tool 1 wants to strip an even larger length of the cable 8, the user can use the stripping tool 1 again as part of a second operating step, in order to enlarge the already stripped first axial partial section 31 of the cable 8. This can also be particularly advantageous when cables 8 with particularly large cross-sections are to be stripped. A stripping process in two operating steps is furthermore always advisable when the desired length to be stripped is longer than a first stripping length 23, which is reached during a first stripping step. The stripping length 23 generally depends on the reached axial shifting between the tool part base 14 and the two partial cutting bodies 17, 18, which, in turn, are due to the wedge angle α of the above-described wedge structure 28 and the protrusion of the edge region 41 of the partial cutting bodies 17, 18 beyond an edge of the tool part base 14. Provided that the user thus wants a stripping with larger length, the shifting distance of the stripping tool 1 is to be increased and/or a second operating step is to be carried out, by which the insulation sheath 7, which has already been shifted in the first operating step, is shifted even further in the direction of the free end region of the cable 8.

In order to carry out the second operating step, the user opens the stripping tool 1, starting at the situation in FIG. 11, in order to remove the tool parts 4, 5 from one another. As is then illustrated in FIG. 12, the user pivots the end stop 25 around the guide rod 42 away from the cable 8. The user can then displace the cable 8 beyond the end stop 25. The cable 8 is preferably placed so that the two cutting parts 10, 11 contacting one another on the front regions 19 of the partial cutting bodies 17, 18 as well as the additional cutting parts 22 of the second partial cutting body 18 are located within the stripped partial section 31 of the cable 8. In particular FIG. 12 discloses this. The outer cutting parts 10 and the additional cutting parts 22 lie within the stripped partial section 31 during the placement. However, both do not abut simultaneously against the insulation sheath 7. On the contrary, a certain play exists and thus an unused stroke region during the second operating step, which decreases the effective shifting distance.

The stripping tool 1 is preferably formed so that the first stripping length 23 reached by the first operating step of the stripping tool 1 is larger than the axial partial section of the cable 8, which is overlapped by the cutting parts 10, 11 as well as the additional cutting part 22. In other words, in the initial position illustrated in FIG. 12, the cutting parts 10, 11 as well as the additional cutting part 22 fit into the stripped partial section 31—at least based on the cutting tips 12, 37 thereof.

As illustrated in FIG. 12, the region 48 of the insulation sheath 7, which is only carved into by the additional cutting part 22 during the first operating step, now lies outside of the stripped partial section 31 and has no further function. It is only shifted uniformly with the already cut-through end section of the insulation sheath 7. A separation of the insulation sheath 7 does not result in this region 48 during the first stripping step because the additional cutting part 22 is only displaced in a stationary manner relative to the cutting part 11 of the second partial cutting body 18 when separating the partial cutting bodies 17, 18.

As illustrated in FIG. 13, a displacement of the first partial cutting body 17 and of the second partial cutting body 18 relative to one another and relative to the tool part base 14 results again during the second operating step by bringing together the tool parts 4, 5. The additional cutting part 22, which was attached beforehand to the shifted end piece of the insulation sheath 7, thereby engages with this separated end piece in the axial direction a and shifts it further in the direction of the free cable end.

The stroke of the stripping tool 1 during this second operating step effects a further displacement of the insulation sheath 7 relative to the cable core 6 by an additional, second stripping length 32. This second stripping length 32, i.e., the additional displacement distance, is smaller than the first stripping length 23 of the first operating step. The user can then pull the end piece of the insulation sheath 7, which was shifted by a second length, off the cable core 6. However, the enlarged shifting length optionally also results in an automatic pushing of the separated end piece of the insulation sheath 7 off the cable core 6.

An end state of the stripping tool 1 after carrying out the second operating step is illustrated in an exemplary manner in FIG. 13. There, the end piece of the insulation sheath 7 only still engages over the cable core 6 with an extremely small axial overlap. The user can thus remove the insulation sheath 7 without noteworthy force.

FIGS. 14 to 19 disclose a further embodiment of the disclosure.

In the case of this embodiment, the first partial cutting body 17 has a first cutting part 10 again, while the second partial cutting body 18 has a second cutting part 11 again. In the initial position illustrated in FIG. 14, the two cutting parts 10, 11 contact one another on the front regions 19 of the partial cutting bodies 17, 18.

In the case of this embodiment, however, no additional cutting parts 22 are arranged on the cutting body 9. According to a further possible embodiment, however, it would also be conceivable to provide the second partial cutting body 18 with an additional cutting part 22 in turn, as it is the case, for example, according to the first exemplary embodiment.

Here, the partial cutting bodies 17, 18 of the tool parts 4, 5 can, in turn, again have receptacles 49, for example grooves, into which a tool element, for example and preferably in the form of a cutting part, can be inserted in a releasable manner. Such an embodiment is conceivable with regard to all of the embodiments proposed here, so that the user can supplement tool elements, such as, for example, cutting parts 10, 11 and additional cutting parts 22, as needed.

Even though this is not illustrated in more detail here, it is conceivable in the first exemplary embodiment as well as in the case of the second exemplary embodiment that the first cutting parts 10 of the first partial cutting body 17 is replaced with a pure holding element 20 (see, for example, FIGS. 43 and 44). Due to the fact that the second cutting part 11 of the second partial cutting body 18 is configured to independently carve into the insulation sheath 7 or to sever it, respectively, it is not absolutely required that the first partial cutting body 17 also has a cutting part 10. A holding element 20, which is formed and configured to hold the axial section of the cable 8 assigned to the first partial cutting body 17 in position, is sufficient in this sense, in particular when the first partial cutting body 17 is shifted along the sloping guide surface 15 of the wedge structure 28 opposite to the displacement direction of the second partial cutting body 18.

As furthermore follows from FIG. 14, the user of the stripping tool 1, in turn, can push or pivot the end stop 25 in front of the cable 8. By bringing together the tool jaws 2, 3, the user then brings the tool parts 4, 5 into the initial position illustrated in FIG. 14, in which the cutting parts 10, 11 of the partial cutting bodies 17, 18 notch the insulation sheath 7. As long as the cutting parts 10, 11 do not yet contact one another, a movement inhibition occurs, in particular a self-locking effect of the cutting parts 10, 11, whereby the cutting parts 10, 11 only notch the insulation sheath 7, but are not yet displaced in the axial direction a.

As soon as preferably at least the edge regions of the cutting tips 12 of the cutting parts 10, 11 come into contact with one another when the bringing-together of the tool parts 4, 5 continues, the opposite cutting parts 10 or 11, respectively, of the opposite tool parts 4, 5 act like a single body, on which forces from opposite directions, namely in each case directions perpendicular to the axial direction a, act. These forces add up to a total force, which acts in the axial direction a. The movement inhibition, in particular optionally self-locking of the cutting parts 10, 11, is eliminated and a displacement of the two partial cutting bodies 17, 18 occurs relative to the tool part base 14, namely in each case along the sloping guide surfaces 15 of the tool part base 14. As described above, the corresponding guide surfaces 15 of the tool part base 14 and of the guide surfaces 16 of the partial cutting bodies 17, 18 can also be formed in a web-shaped manner.

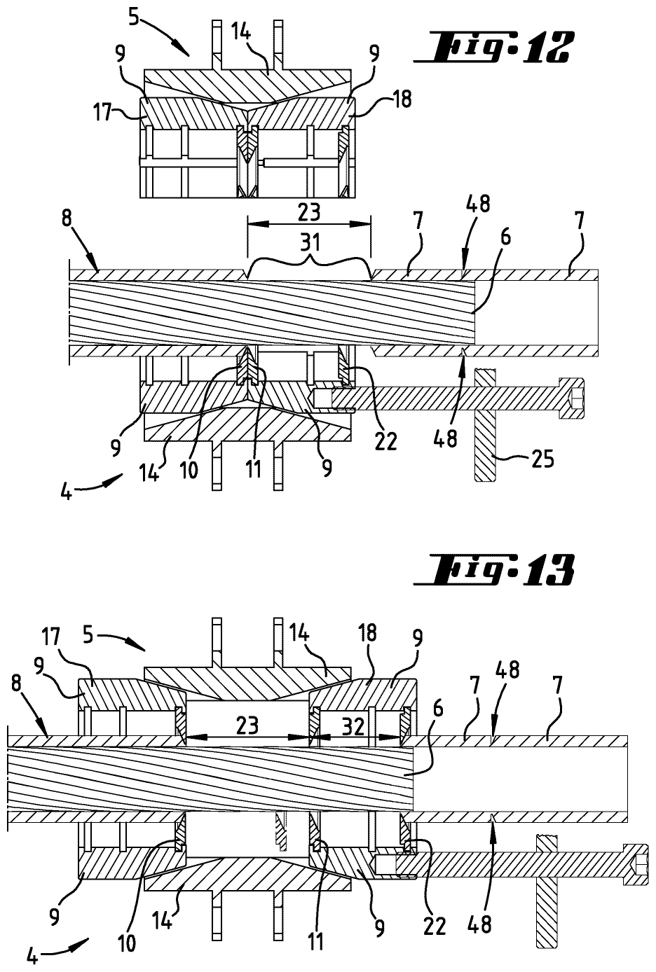

When the tool parts 4, 5 are completely brought together, i.e., when the tool part base 14 of the first tool part 4 and the tool part base 14 of the second tool part 5 contact one another, the end position illustrated in FIG. 15 is reached. The cutting parts 10, 11 of the partial cutting bodies 17, 18 are then separated from one another by the first stripping length 23. The first stripping length 23 is thus simultaneously also the length of the stripped axial partial section 31 of the cable 8, on which the cable core 6 is exposed.

According to this proposed embodiment, the user, starting at the end position illustrated in FIG. 15, initially slightly opens the working head 35 of the stripping tool 1 again, so that the opposite tool parts 4, 5 no longer contact one another and the cable 8 can be displayed relative to the cutting bodies 9.

As illustrated in FIGS. 16 and 17, the user initially brings together the partial cutting bodies 17, 18 on the front regions 19 thereof again, so that the cutting parts 10, 11 of the adjacent partial cutting bodies 17, 18 contact one another again. This can optionally also be attained automatically or at least supported by a resetting element, which engages with the partial cutting bodies 17, 18 and which acts in the axial direction a, for example a tension or pressure spring element 62, the resetting force of which seeks to displace the partial cutting bodies 17, 18 towards one another when an engagement force on the tool jaws 2, 3 or tool parts 4, 5, respectively, is eliminated.

The user subsequently positions the cutting parts 10, 11 guided on one another on the stripped partial section 31 of the cable 8, namely so that the second cutting part 11 supports itself on the cutting edge 53 of the separated end piece of the insulation sheath 7.

The user arranges an additional holding element 21 at the end region of the first partial cutting body 17 facing away from the cutting part 10, as illustrated in FIGS. 16 and 17. The additional holding element 21 is inserted here, for example, between the free end region of the first partial cutting body 17 and the cutting edge 53 of the insulation sheath 7, for example clamped to the partial cutting body 17.

According to the embodiment illustrated here, the additional holding element 21 can be a separate tool element of the stripping tool 1, which the user clamps to the cable 8, for example, as needed.

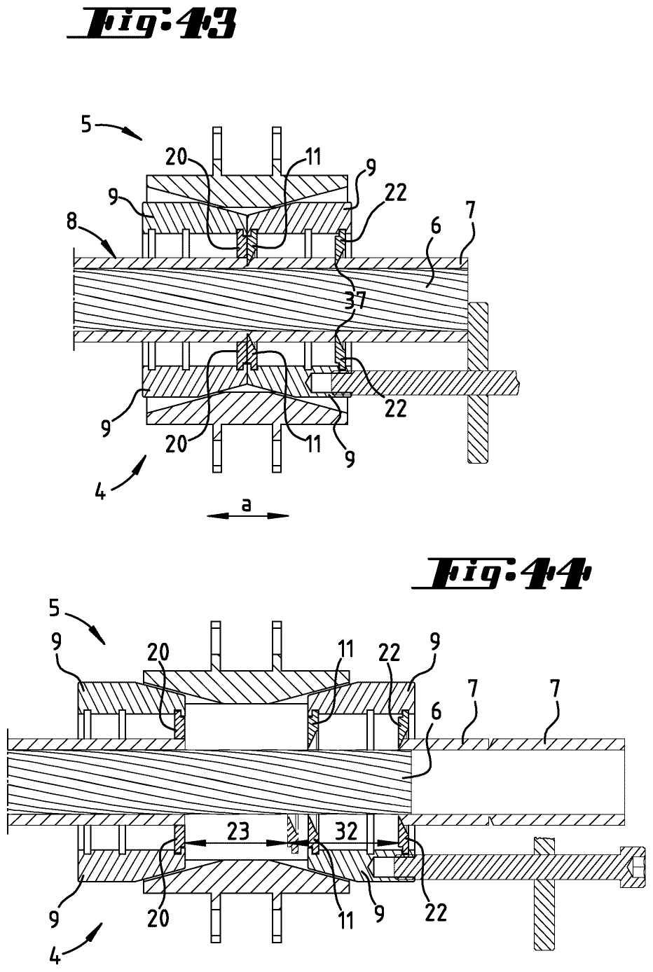

Alternatively, it is also possible, however, that the additional holding element 21 is permanently arranged on the stripping tool 1, in particular one of the first partial cutting bodies 17, and can be arranged on the cable 8 by the user as needed, in order to hold it in position. In this case, the additional holding element 21 can be pushed, for example, against the cable 8 by a linear pushing movement or can be pivoted against the cable 8 by a pivoting movement. The latter is illustrated in FIGS. 45 and 46.

In the embodiment illustrated here, the additional holding element 21 is a metal sheet comprising a slit-shaped recess (slit 24), into which the cable 8 can be pushed. Within the slit 24, the cable 8 is squeezed on its circumferential surface and is thus fixed in a position relative to the first partial cutting body 17.

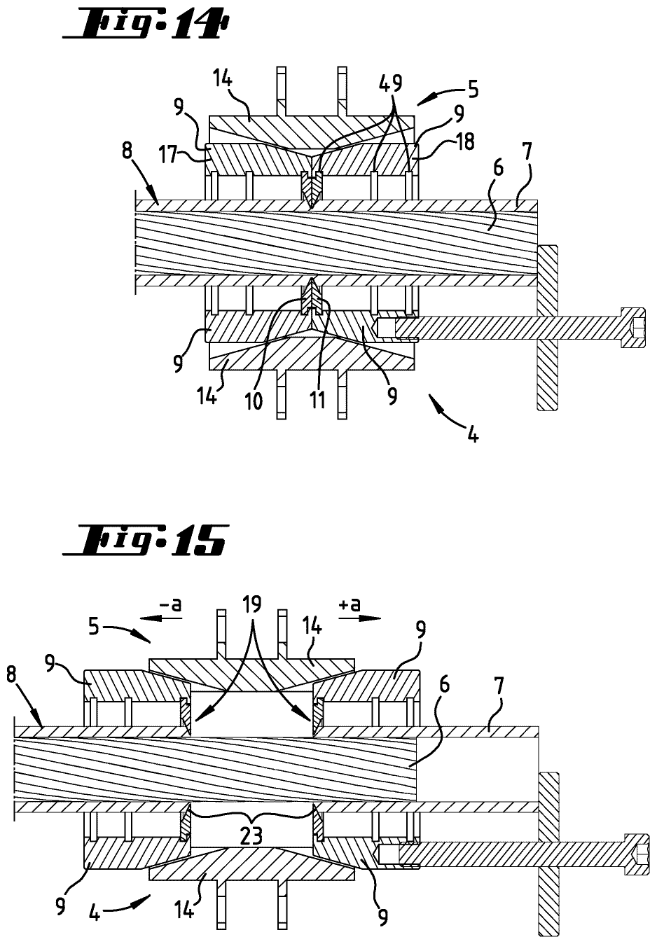

Starting at the situation according to FIGS. 16 and 17, the user can then effect a renewed bringing-together of the tool parts 4, 5, in order to create an axial force again, which displaces the two partial cutting bodies 17, 18 away from one another. While pushing apart the two partial cutting bodies 17, 18 in opposite axial directions −a and +a, the second cutting part 11 of the second partial cutting body 18 pushes against the end piece of the insulation sheath 7, which has already been displaced in the first operating step, on the one hand, while the additional holding element 21 acts against the interface of the residual piece of the cable 8 during the displacement of the first partial cutting body 17 in the opposite axial direction-a, on the other hand. As illustrated in FIGS. 18 and 19, this second stroke of the stripping tool 1 during the second operating step then leads to a renewed displacement of the end piece of the insulation sheath 7, which has already been shifted in the first operating step, by an additional second stripping length 32. The end piece of the insulation sheath 7 was thus shifted by the first stripping length 23 relative to the cable core 6 during the first operating stroke and additionally by the second stripping length 32, which can be approximately as large as the first stripping length 23, during the second operating stroke.

According to the end position illustrated in FIG. 19, the stripped end piece of the insulation sheath 7 has already been automatically lifted off the cable core 6 by the second stroke of the stripping tool 1, so that the user does not have to manually intervene any longer, for example by pulling on the end piece of the insulation sheath 7.

FIGS. 20 and 21 show an embodiment of a cutting part 10, 11 for inserting into the tool part 4, 5 of one of the preceding embodiments, which will be described below. For stripping a cable 8, the cutting part 10, 11 is formed with a defined diameter. For this purpose, the cutting tip 12 of the cutting part 10, 11 limits a free space 13, which is preferably larger than an outer diameter of a cable core 6 of the cable 8 to be stripped. When attaching the cutting part 10, 11 to the cable 8 to be stripped, the cutting tip 12 only severs the insulation sheath 7 but does not come into contact with the cable core 6. A complete severing of the insulation sheath 7 can take place thereby or also a non-complete severing, whereby a small thickness of the insulation sheath 7, which is torn through as a result of axially moving apart the two partial cutting bodies 17, 18, still remains on the outer side of the cable core 6.

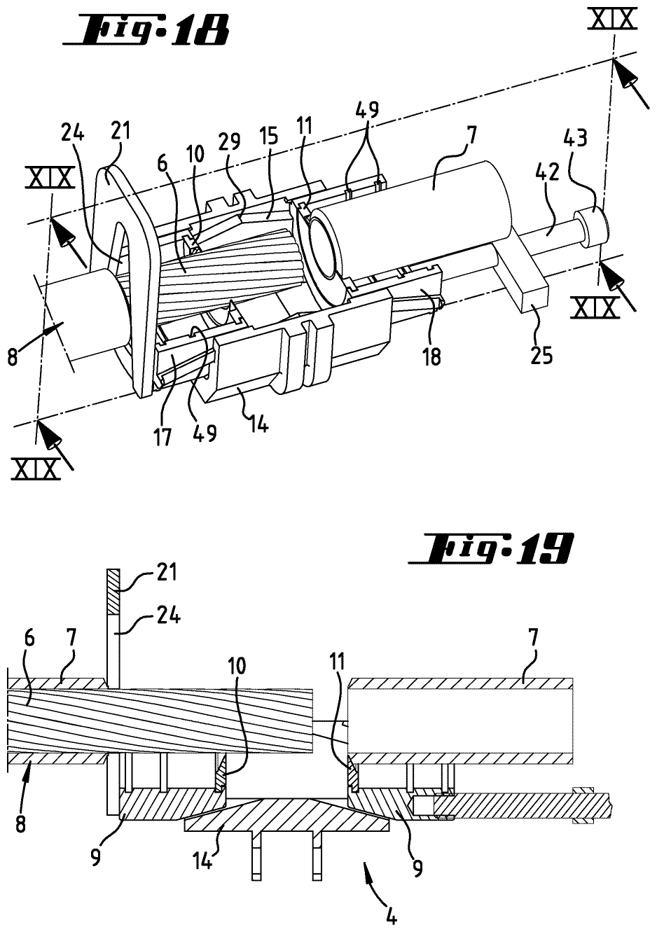

FIGS. 22 and 23 show an embodiment of a cutting part 33 for inserting into the tool part 4, 5 of one of the preceding embodiments, which will be described below as an alternative to the cutting parts 10, 11. The cutting part 33 has two different cutting tips 12 next to one another, which forms free spaces 13 of different sizes. Depending on the outer diameter of a cable 8 to be stripped, the user can insert the cable 8 into one of the free spaces 13. Cutting part 33 comprising an even larger plurality of cutting tips 12 are generally also conceivable.

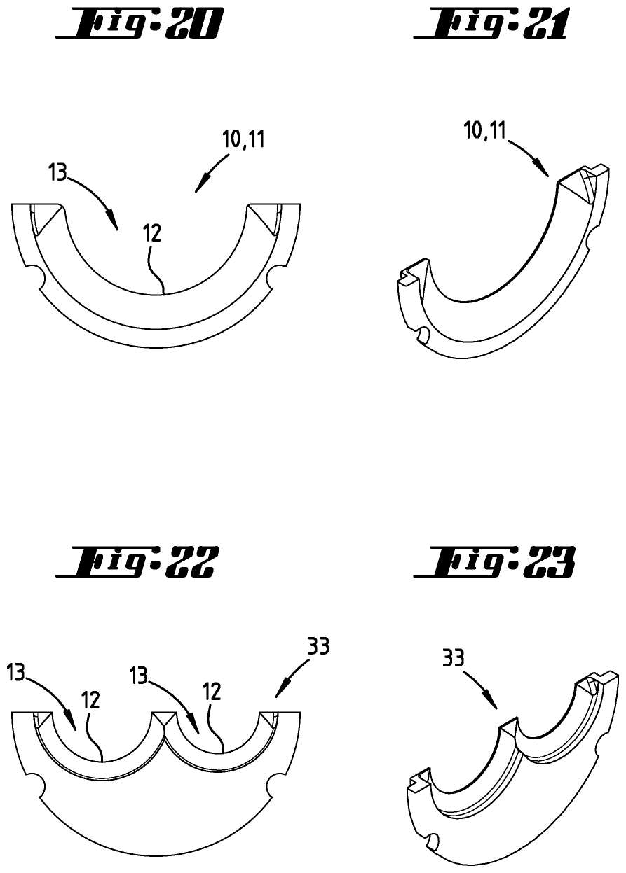

FIGS. 24 to 30 disclose a further embodiment of a pair of tool parts 4, 5 for the stripping tool 1. The tool parts 4, 5 simultaneously strip a cable 8 introduced into a receiving region 38 at a first axial position and to cut through the cable 8 at a second axial position. The user can thus simultaneously shorten and strip the cable 8. For this purpose and as can further be seen starting with FIG. 25, each tool part 4, 5 initially has a tool part base 14 and partial cutting bodies 17, 18 mounted thereon so as to be shiftable in the axial direction a. On their front regions 19 facing one another, the partial cutting bodies 17, 18 each have a cutting part 10, 11. The cutting parts 10, 11 have cutting tips 12, which limit the free space 13, which corresponds to a corresponding cable diameter, preferably in such a way that the diameter of the free space 13 is exactly as large as or slightly larger than an outer diameter of the cable core 6 of the cable 8.

In addition to the first cutting parts 10, each first partial cutting body 17 has an additional holding element 21, which serves the purpose of fixing the cable 8 relative to the respective first partial cutting body 17 in particular during a second stripping step. In addition to the second cutting part 11, each second partial cutting body 18 has an additional cutting part 22, which preferably serves the purpose of completely severing the cable 8. These additional cutting parts 22 have linear cutting tips 26, so that the additional cutting parts 22 are preferably formed semi-circularly here.

Alternatively, it is also conceivable to use an additional cutting part 22 formed by a concavely shaped cutting tip 26. In the case of this embodiment, opposite additional cutting parts 22 of the first tool part 4 and of the second tool part 5 glide past one another when bringing together the tool jaws 2, 3. A possible cutting gap between the opposite additional cutting parts 22, based on the axial direction a, must not become too large thereby and requires an exact opposing position of the additional cutting parts 22. Alternatively, it is also possible that the opposite additional cutting parts 22 are held so as to be pivotable about an axis, which is oriented transversely to the axial direction a. In the case of this embodiment, a cutting force of the additional cutting parts 22 acting on the cable 8 to be cut causes a counterforce of the cable 8, which preferably lies on a different line of action than the line of action of the cutting force, so that a torque pivoting the additional cutting parts 22 is created. The opposite additional cutting parts 22 are thus pivoted in such a way that a cutting gap existing between them is eliminated or at least reduced.

FIG. 26 shows a cutting of the cable 8 during a first operating step. While bringing together the tool parts 4, 5, a carving of the insulation sheath 7 takes place by the cutting parts 10, 11, while, as further illustrated in more detail in FIG. 27, the additional cutting parts 22 of the cable 8 located opposite one another sever the cable 8 completely. The bringing together of the opposite tool parts 4, 5 thus already effects a shortening of the cable 8 in the brought-together initial position of the tool parts 4, 5, while a notching or carving, respectively, only of the insulation sheath 7 takes place simultaneously at a different axial position of the cable 8, namely where the cutting parts 10, 11, which bear against one another, of the two partial cutting bodies 17, 18 are located.

The opposite tool parts 4, 5 furthermore each have guide arms 51, which, starting at the respective tool part 4, 5, extend in the direction of the opposite tool part 4, 5. Each tool part 4, 5 has, for example, two guide arms 51 here, which are formed on diagonally opposite corner regions of the tool part 4, 5. The guide arms 51 are formed to release a movement of the partial cutting bodies 17, 18 in the axial direction a only when the opposite tool parts 4, 5 are brought together almost completely. For example, end regions 52 of the guide arms 51 initially block the partial cutting bodies 17, 18 from moving outwardly relative to the tool part base 14. The guide arms 51 provide for a positive control of the axial shifting of the partial cutting bodies 17, 18 alternatively to a displacement, which is controlled, for example, by friction and self-locking. The positive control prevents the occurrence of an immediate shifting of the second partial cutting body 18 together with the cable 8 that when the additional cutting parts 22 abuts against the cable 8 because the adjacent partial cutting body 17 of the same cutting body 9 is not yet in contact with the cable 8 and can thus not yet compensate the resulting force in the axial direction a. A frictional force between the cable 8 and the cutting part 10 of the first partial cutting body 17 thus does not exist because the cable 8 moves together with the cutting part 11 and the additional cutting part 22 of the second partial cutting body 18. In the end position of the tool parts 4, 5, the guide arms 51 are accommodated in a recess 54 of the opposite tool part 4, 5. In this end position, the end region 52 is brought into a position that permits the axial displacement of the partial cutting body 17, 18 (see FIG. 24a). Before reaching the end position, the end region 52 in particular is in a locking position in front of the facing surface of the partial cutting body 17, 18, so that it cannot be axially displaced.

Without the effect of the guide arms 51, the cable 8 would thus not be cut through by the additional cutting parts 22 or only when the partial cutting bodies 17, 18 are in a position, which is maximally spaced apart from one another, respectively. The guide arms 51 thus serve the purpose of a positive locking in the form of an edge control, which locks the opposite tool parts 4, 5 until the tool jaws 2, 3 are almost completely brought together.

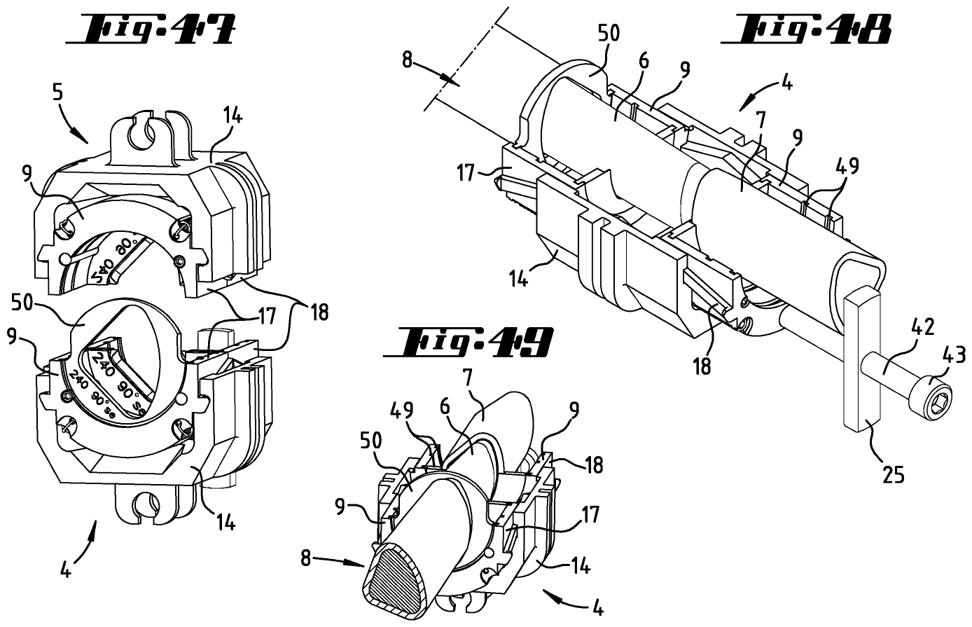

Alternatively, it is also possible to prevent the axial displacement of the partial cutting bodies 17, 18 by other control elements until the tool parts 4, 5 are brought together almost completely. Alternatively to the guide arms 51, for example, retractable control elements can also be used, which are actuated only when the partial cutting bodies 17, 18 of the opposite tool parts 4, 5 bear against one another (see FIGS. 50 to 53). For example, these control elements can be journals 55, which protrude beyond the contact surfaces of the partial cutting bodies 17, 18 in the circumferential direction, which are retracted into the respective assigned partial cutting body 17, 18 as part of a bringing together of the tool parts 4, 5, and thereby release the displacement in the axial direction a. As long as the opposite tool parts 4, 5 are not completely brought together yet, the journals engage behind an undercut and thus prevent the axial displacement of the partial cutting bodies 17, 18 relative to one another. Only when the tool parts 4, 5 are almost completely brought together, the journals are displaced (retracted) and can be guided past the undercut, in order to release the axial displacement.

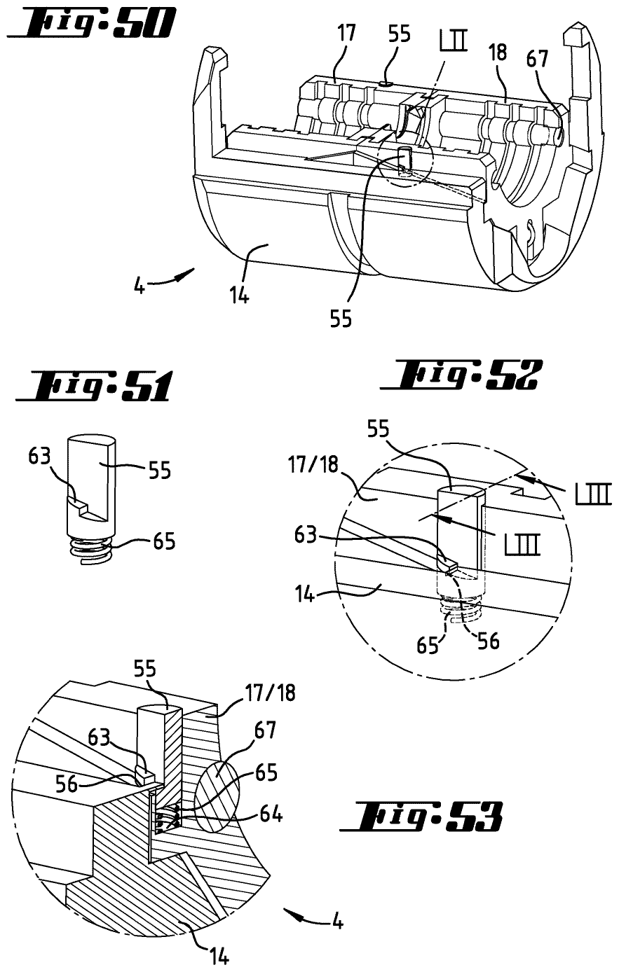

With reference to FIGS. 50 to 53, an embodiment is illustrated, which is a possible design even independently of the concretely illustrated embodiment of the tool parts 4, 5 for all of the tool parts 4, 5 described here. This embodiment relates to a further option for attaining the desired holding force, which is required for changing from the notching into the insulation sheath 7 to the axial shifting of the partial cutting bodies 17, 18 when carrying out a cutting process. As can be seen, the holding force is thereby attained by means of a journal 55, which is guided in the partial cutting body 17, 18 and which is under spring force from a spring element 65 and which can cooperate with a stop 56 formed on the tool part base 14 until a state, as it is given, for instance, by FIGS. 3 and 4. The journal 55 thereby has a protrusion 63, which abuts against the stop 56, as illustrated in FIGS. 52, and which is displaced below the level of the stop 56 when lowering the journal 55, and which is subsequently shifted in the axial direction a below the stop 56 in a guide groove 64 of the tool part base 14. The lowering of the journal 55 is triggered by further moving together the tool jaws 3, 4 or tool parts 4, 5, respectively, for example starting at the position illustrated in FIGS. 3 and 4. By means of further moving together the tool parts 4, 5, the resetting force of the spring element 65, which is coupled to the journal 55, is overcome, and the corresponding displacement of the partial cutting bodies 17, 18 relative to the tool part base 14 is attained. This is thus a generation of a holding force, which is essentially based on a positive connection.

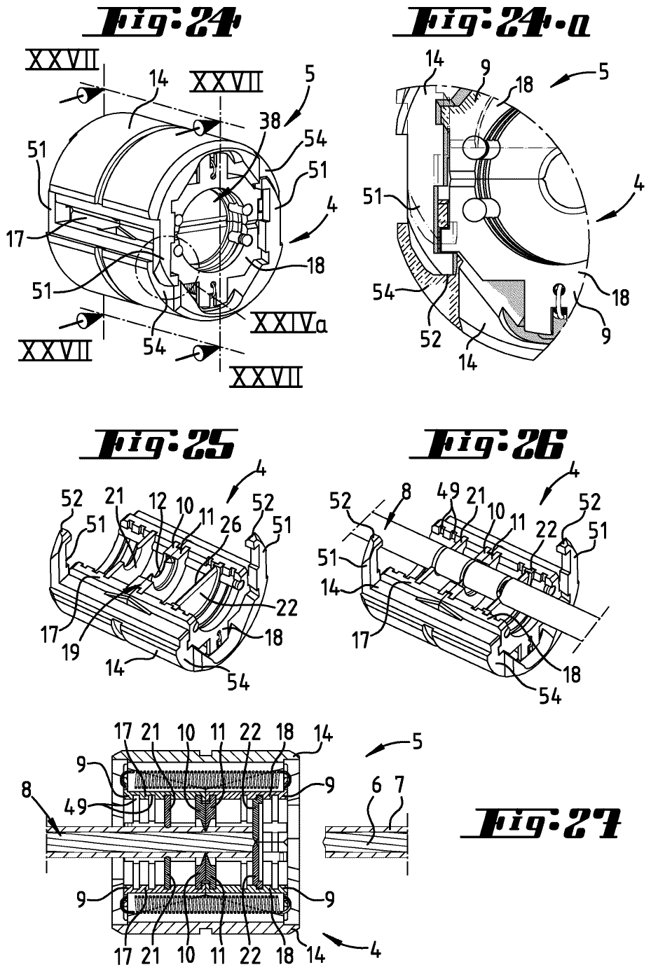

The user then moves the opposite tool parts 4, 5 further towards one another, whereby the partial cutting bodies 17, 18 of the respective tool part 4, 5, based on the axial direction a, are moved apart, so that the end state illustrated in FIGS. 28 to 30 is reached.

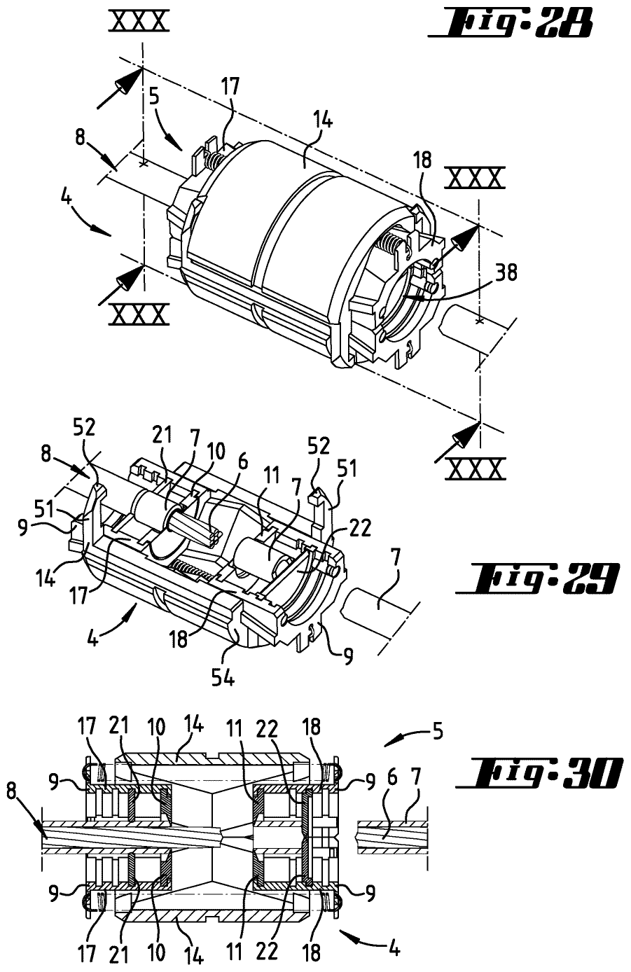

As can be seen in particular on the basis of FIGS. 29 and 30, the cable 8 has been shortened thereby in the region of the additional cutting parts 22 and the (shortened) end region of the cable 8 is completely stripped, namely in the region of the first cutting parts 10 of the first partial cutting body 17. The residual cable was held back by the additional holding element 21 as well as the first cutting parts 10 in response to moving apart the partial cutting bodies 17, 18 or the cutting parts 10, 11, respectively, while the piece of the insulation sheath 7 pushed away from the cable core 6 was pushed down completely from the cable core 6 and remains on the second partial cutting body 18 between the second cutting part 11 and the additional cutting part 22.

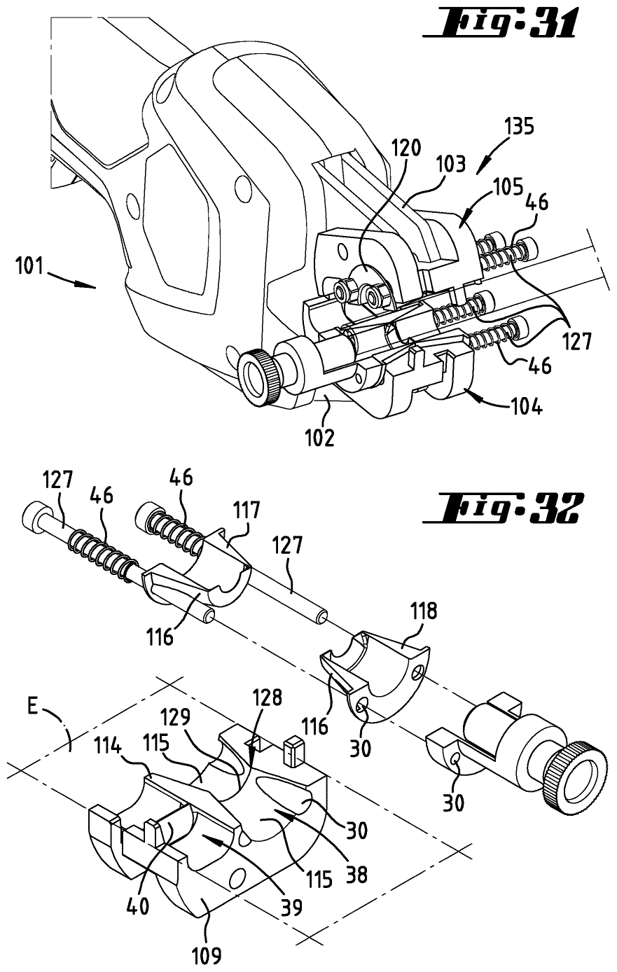

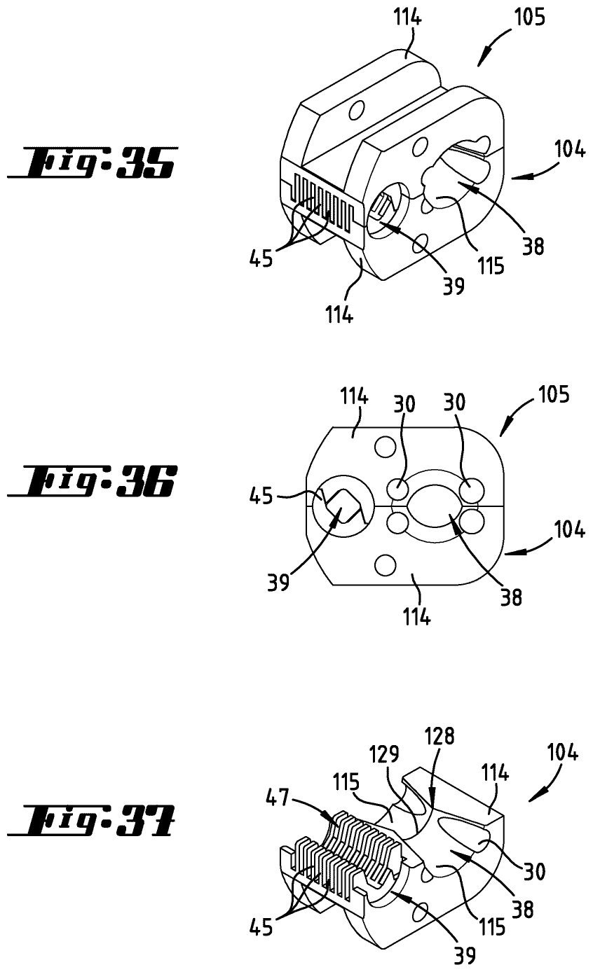

FIGS. 31 to 37 show two further possible embodiments for a pair of tool parts 104, 105. Each tool part 104, 105 has two receiving regions 38, 39 which are arranged parallel to one another. Each receiving region 38, 39 is formed for receiving a cable 8, whereby the cable 8 can be inserted either into the first receiving region 38 or into the second receiving region 39, depending on the desired function of the stripping tool 101. The user can thus carry out different operating steps on the same stripping tool 101, in that the user initially inserts the cable 8 into the second receiving region 39, for example, for shortening, then displaces the cable 8 parallel into the first receiving region 38 transversely to the longitudinal extension thereof and thus also transversely to the axial direction a, and subsequently also strips the cable 8 there on the end side. The receiving regions 38, 39 are located next to one another in a cross sectional plane E orthogonal to the axial direction a (see FIG. 32).

The stripping tool 101 or the illustrated working head 135 thereof, respectively, has, for example, two tool jaws 102, 103, which can be pivoted relative to one another. The tool parts 104, 105 are held on the respective tool jaw 102, 103 by rod-shaped holding elements 127. A spring element 46 is in each case arranged on the respective holding element 127 outside of the tool parts 104, 105 and outside of the tool jaws 102, 103. The spring elements 46 are formed as helical springs, which are pushed onto the holding element 127 in the axial direction a. The spring elements 46 act as pressure springs, which seek to push together the partial cutting bodies 117, 118 of the respective tool part 104, 105 by counter bearing on a front-side end region of the holding element 127. The resetting force of the spring elements 46 thus act in such a way that the partial cutting bodies 117, 118 assume the basic position illustrated in FIG. 31. To receive the holding elements 127, the partial cutting bodies 117, 118 as well as the tool part base 114 and the tool jaws 102, 103 have passage openings 30. The holding element 127, based on a circumferential direction thereof, at least partially passes through the cutting body 109 and at least partially through at least one of the following tool elements: the cutting parts 10, 11, the holding element 20, the additional holding element 21, the additional cutting parts 22, the guide element 50.

In the exemplary embodiment illustrated here, the inner surface of each tool part base 114 facing the partial cutting bodies 117, 118 is formed conically. Each tool part base 114 furthermore provides a wedge structure 128 with a wedge peak 129 and guide surfaces 115, which slope symmetrically in both opposite axial directions −a and +a, starting at the wedge peak 129. The gradient of the guide surfaces 115 corresponds to a gradient of a corresponding guide surface 116 of the respective partial cutting body 117, 118, whereby the guide surfaces 115, 116 of tool part base 114 and partial cutting bodies 117, 118 preferably bear completely against one another in the initial position shown in FIG. 33. The guide surfaces 115, 116 of tool part base 114 and partial cutting bodies 117, 118 are formed here in an exemplary manner as conical surfaces. A cone angle of the guide surfaces 115, 116 is identical. This preferably applies at least in a surface region of the contact, i.e., along a contact line of the surfaces, which are swept over. A remaining partial region of the guide surfaces 115, 116 could essentially be designed arbitrarily. A displacement of the guide surfaces 16 of the partial cutting bodies 117, 118 relative to the guide surface 115 of the tool part base 114 takes place only in response to the separation of the partial cutting bodies 117, 118 in the axial direction a, whereby different contact diameters of the guide surfaces 115, 116 result, so that the guide surfaces 115, 116 essentially only contact one another in a linear fashion in the axial direction a. This leads to a parallel alignment of the partial cutting bodies 117, 118 relative to one another as well as to an optimally parallel positioning of the cable 8 between the corresponding tool parts 104, 105.

When the user displaces the opposite tool parts 104, 105 further towards one another, starting at the initial position suggested in FIG. 33, the partial cutting bodies 117, 118 are separated in the region of the wedge peak 129 of the wedge structure 128 of the tool part base 114 against the resetting force of the spring elements 46. A shifting of the insulation sheath 7 relative to the cable core 6 thus results, as already described in detail above with reference to the further exemplary embodiments.

Provided that the user wants to carry out a shortening of the cable 8 prior to the stripping step, the user can initially insert the cable 8 into the second receiving region 39 and can shorten the cable 8 by the cutting parts 40 arranged there.

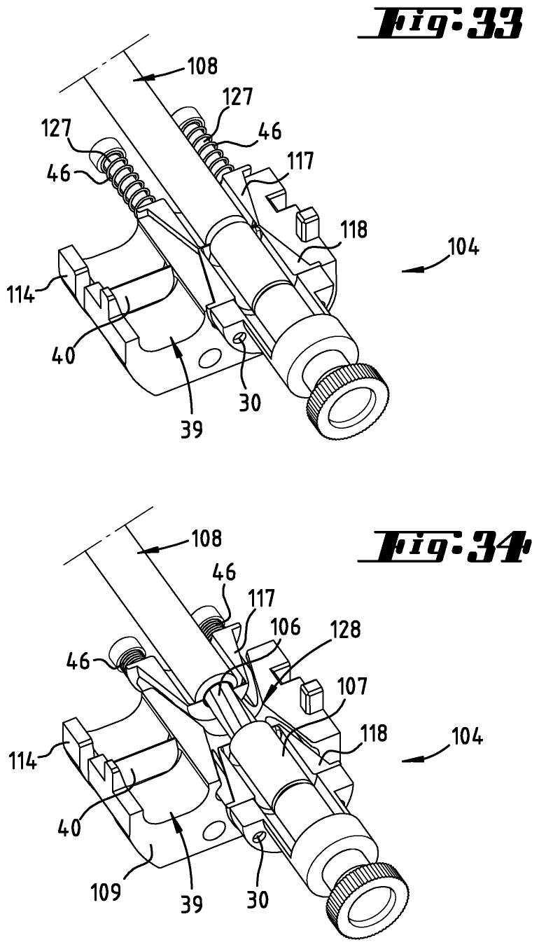

FIGS. 35 to 37 likewise show a pair of tool parts 104, 105 comprising two receiving regions 38, 39. The first receiving region 38 is likewise formed here again for stripping a cable 8, while the second receiving region 39 has a crimping part 47. The crimping part 47 serves for a crimping process, i.e., for pressing a stripped end region of a cable 8, for example with a cable end sleeve. For this purpose, the crimping part 47 has, for example, a plurality of ribs 45 here which in an embodiment extend transversely to the axial direction a. According to this embodiment, the user can thus initially strip a cable 8 on the end side within the first receiving region 38 and can finally crimp the cable core 6 exposed on the end side within the second receiving region 39. For this purpose, the user has to displace the cable 8 from the first receiving region 38 into the second receiving region 39.

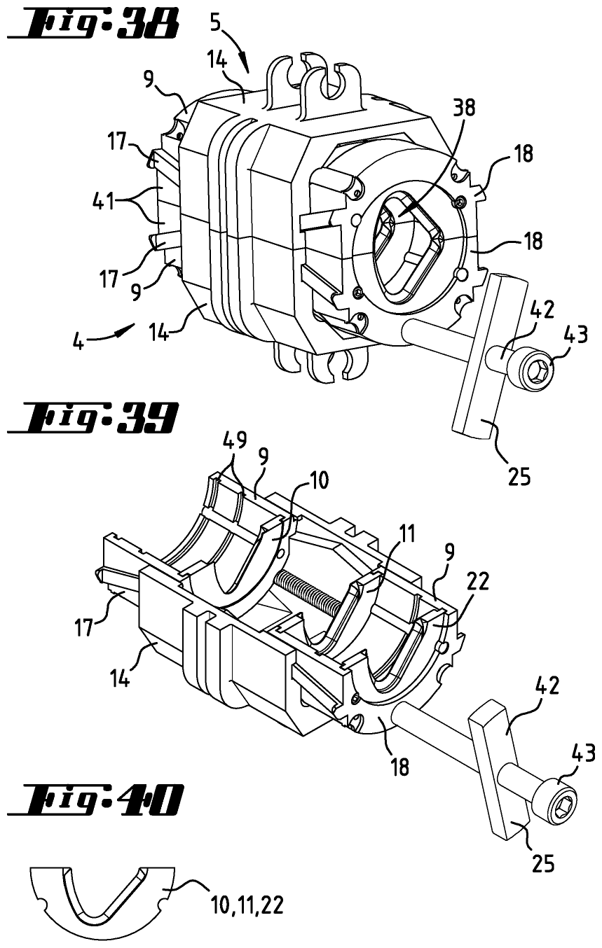

FIGS. 38 to 40 show a pair of tool parts 4, 5, each of which has two cutting parts 10, 11 as well as an additional cutting part 22. The cutting parts 10, 11 as well as the additional cutting part 22 are formed for cutting a sector-shaped cable with non-round cross section. Apart from that, the use of a stripping tool 1 equipped with this pair of tool parts 4, 5 takes place according to the first described embodiment.

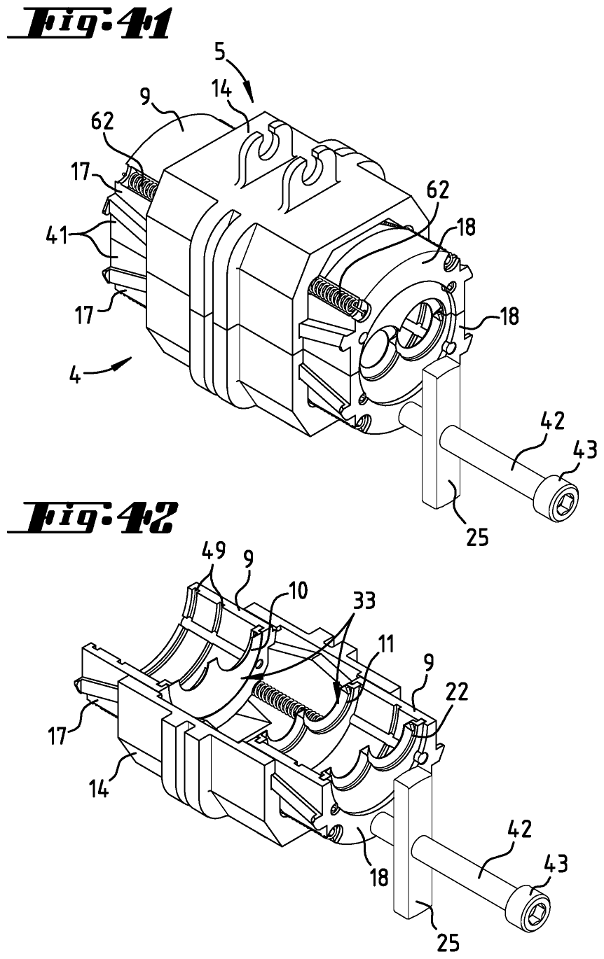

FIGS. 41 and 42 disclose a further embodiment of a pair of tool parts 4, 5. According to this embodiment, each tool part 4, 5 has cutting parts 10, 11 as well as an additional cutting part 22, which, like the cutting parts 33 according to FIGS. 22 and 23, provide two differently formed free spaces 13 for stripping a cable 8. Cutting tips 12 of these cutting parts 33 can strip cables 8 with different cable diameters. Depending on the size of the cable 8 to be stripped, the user can thus use one of the free spaces 13.

FIG. 43 finally shows a possible alternative, for example for the first embodiment illustrated in FIGS. 1 to 13. In the case of this embodiment, the first partial cutting bodies 17 do not have cutting parts on its front region 19, but instead has a holding element 20. The use of a pair of tool parts 4, 5 formed in this way during a first operating step (analogously to, for example, FIG. 11 of the first embodiment) as well as during a second operating step (analogously to, for example, FIG. 13 of the first embodiment) is then such that the residual piece of the cable 8, which is not to be stripped, is fixed relative to the first partial cutting body 17 by the holding element 20. The cutting function for stripping the cable 8 during the first operating step takes place solely by the second cutting parts 11 of the second partial cutting bodies 18.

The holding element 20 can be formed as a pressing part and can hold the cable 8, for example, only by a frictional force. This takes place, for example, under deformation of the insulation sheath 7 of the cable 8. Alternatively, it is also possible that the holding element 20 has, for example, needle-shaped regions, which pierce into the insulation sheath 7. Other embodiments are also conceivable.

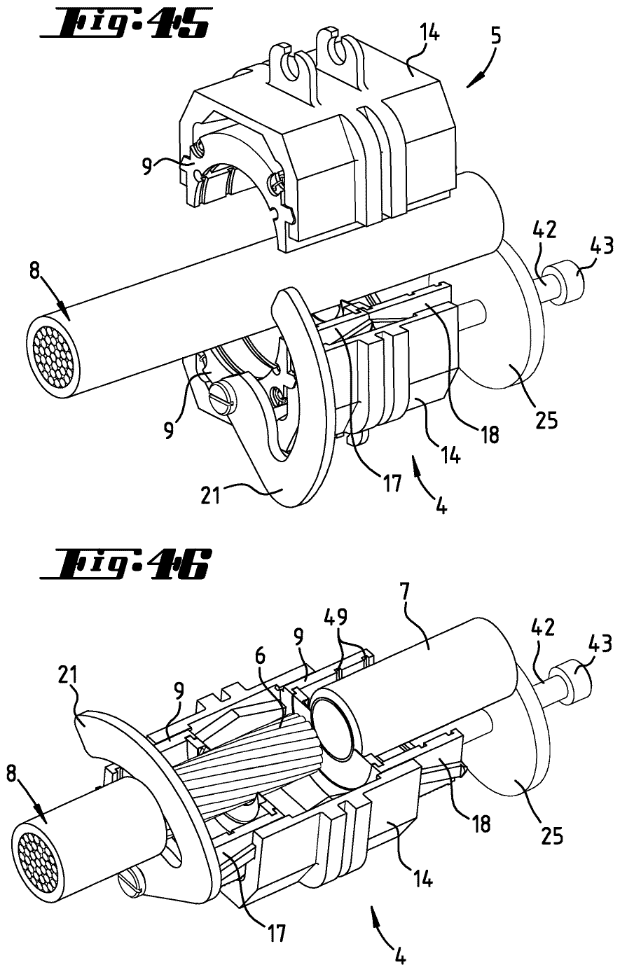

FIGS. 47 to 49 show a further embodiment of a pair of tool parts 4, 5. According to this embodiment, the first tool part 4 has a guide element 50, which serves the purpose of stripping a cable 8 formed as sector-shaped conductor. The guide element 50 is formed as a guide disk, the opening of which is adapted here, for example, to the circumferential contour of a sector-shaped conductor with a sector angle of 90 degrees. The guide element 50 serves the purpose of roughly orienting the sector-shaped conductor during the insertion between the opposite tool parts 4, 5, in order to prevent an incorrect insertion of the cable 8. The opening of the guide element 50 is therefore so large that a certain play remains between the cable 8 and the guide element 50, whereby the cable 8 can be comfortably inserted through the triangular opening of the guide element 50. According to a further embodiment, it can also be provided that the guide element 50 is shiftably mounted relative to the tool part 4, here in particular the first partial cutting body 17.

With an arrangement of two pairs of cutting parts 10 and 11 in the cutting bodies 9, these four cutting parts 10 and 11 can have the same cutting radii t in the area of their cutting tips 12—as essentially shown in FIGS. 1 to 53.

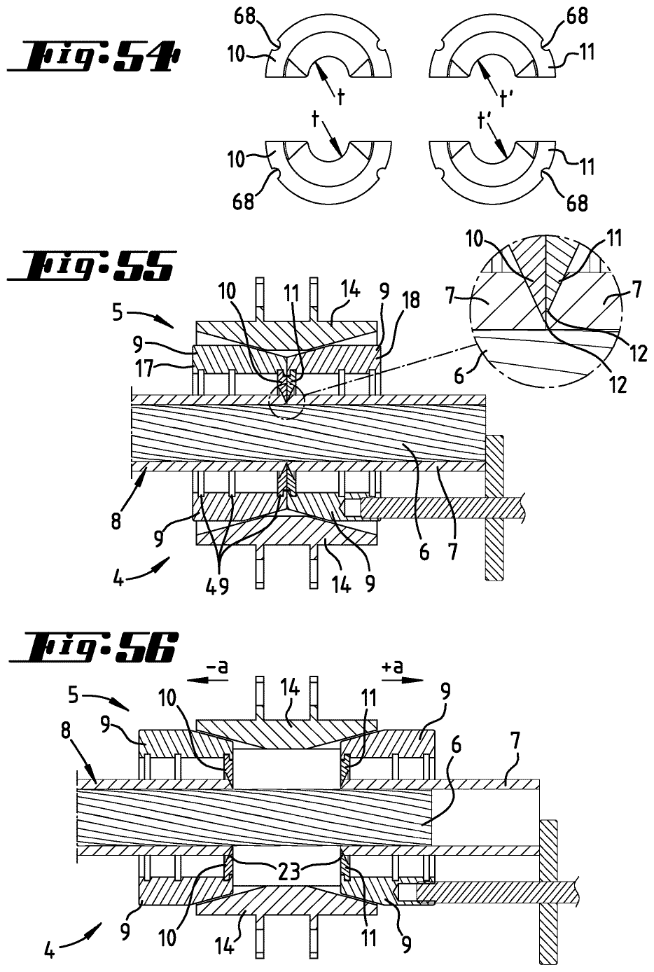

FIGS. 54 to 56 show an embodiment in which different radii are selected in pairs in the area of the cutting tips 12. Thus, the cutting parts 11 facing the section 57 of the insulation sheath 7 to be cut off can have a larger cutting radius t′ compared to the other cutting parts 10. For example, the cutting radius t′ of the cutting parts 11 can correspond to approximately 1.05 times to 1.15 times, more preferably approximately 1.1 times the cutting radius t of the cutting parts 10 (see also the enlarged view in FIG. 55).

As a result of the different cutting radii t, t′, the cut edge 53 facing away from the section 56 of the insulation sheath 7 to be cut off has a cut pattern that is essentially free of tears or breakouts. Overall, this design can result in an improved cutting pattern, even if the cutting parts 11 with a larger radius t′ do not completely cut through the insulating sheath 7, but only the cutting parts 10 with a smaller radius t can.

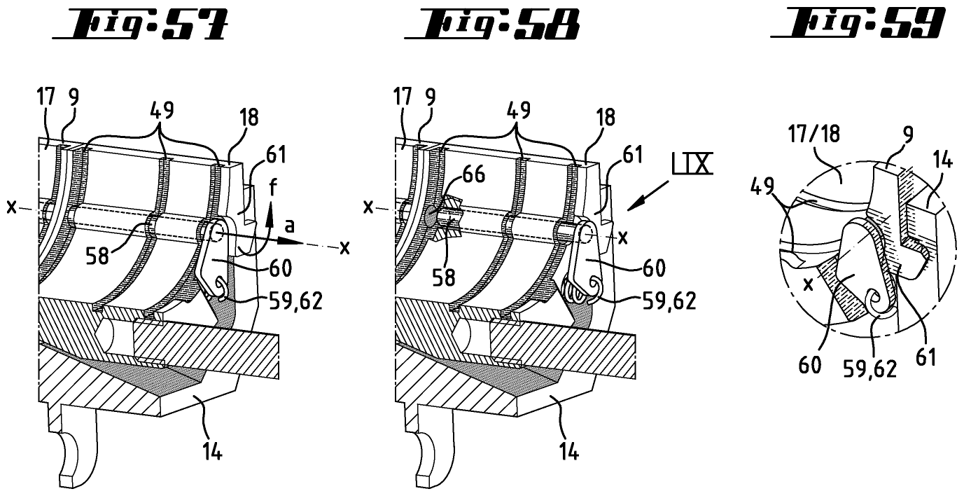

In order to achieve reversible fastening, in particular of the cutting parts 10, 11 or also, for example, of the additional cutting parts 22 in the cutting body 9, a pin 58 that can be displaced in the axial direction a can be held in the cutting body 9 (see further embodiment in FIGS. 57 to 59).

In a locking position, the pin 58 passes through the one receptacle 49 or the multiple receptacles 49 in a locking manner, so that this can also achieve locking of the cutting parts 10, 11 seated in the receptacles 49.

The pin 58 is loaded into the locking position against the restoring force of a spring element 59 (preferably a tension spring).

From the locked position, the pin 58 can be pulled in the axial direction and finally brought into a self-holding position by rotating the pin 58 about its pin axis x. By this rotation in the direction of arrow f (see FIG. 57), a handling section 60 projecting essentially radially outwards from the pin 58 is brought into a rear grip position in relation to the end face 61 of the cutting body 9. In this rear grip position, the pin 58 is self-locking in the release position (see FIGS. 58). The self-locking can only be released by deliberately rotating the pin 58 back against the direction of the arrow f.

The cutting parts 10, 11 are held in the partial cutting body 17 or 18, preferably via two pins 58, both in the circumferential direction and in the direction of arrow r.

For this purpose, the pins 58 pass through a bore-like receptacle 67 (see FIG. 50) of the partial cutting body 17, 18.

The cutting part 10, 11 has a notch 68 (see FIG. 54) on its edge, in which the pin 58 engages in the holding position.

After retraction of the pin 58 and removal of the cutting part 10, 11 from the receptacle 67, an opening 66 is exposed in the receptacle 67 to receive the free pin end in the holding position (see FIG. 58).

In a further possible embodiment, the return effect of the pin 58 into the locking position can also be achieved by the spring element 62, which also pulls the tool parts 4 and 5 together.

List of Reference Numerals

| | | | |
|---|---|---|---|
| 1 | stripping tool | 30 | passage opening |
| 2 | tool jaw | 31 | partial section |
| 3 | tool jaw | 32 | stripping length |
| 4 | tool part | 33 | cutting parts |
| 5 | tool part | 34 | handle region |
| 6 | cable core | 35 | working head |
| 7 | insulation sheath | 36 | crimping part |
| 8 | cable | 37 | cutting tip |
| 9 | cutting body | 38 | receiving region |
| 10 | cutting parts | 39 | receiving region |
| 11 | cutting parts | 40 | cutting parts |
| 12 | cutting tip | 41 | edge region |
| 13 | free space | 42 | guide rod |
| 14 | tool part base | 43 | locking means |
| 15 | guide surface | 44 | actuating element |
| 16 | guide surface | 45 | rib |
| 17 | partial cutting body | 46 | spring element |
| 18 | partial cutting body | 47 | crimping part |
| 19 | front region | 48 | region |
| 20 | holding element | 49 | receptacle |
| 21 | additional holding element | 50 | guide element |
| 22 | additional cutting parts | 51 | guide arm |
| 23 | stripping length | 52 | end region |
| 24 | slit | 53 | cutting edge |
| 25 | end stop | 54 | recess |
| 26 | cutting tip | 55 | control element |
| 27 | holding element | 56 | undercut |
| 28 | wedge structure | 57 | section |
| 29 | wedge peak | 58 | pin |
| 59 | spring element | a | axial direction |
| 60 | handling section | b | distance |
| 61 | end face | f | arrow |
| 62 | spring element | r | engagement direction |
| 63 | protrusion | t | cutting radius |
| 64 | guide groove | t′ | cutting radius |
| 65 | spring element | x | pin axis |
| 66 | opening | | |
| 67 | receptacle | α | wedge angle |
| 68 | notch | β | obtuse angle |
| 101 | stripping tool | | |
| 102 | tool jaw | E | cross sectional plane |
| 103 | tool jaw | | |
| 104 | tool part | | |
| 105 | tool part | | |
| 109 | cutting body | | |
| 114 | tool part base | | |
| 115 | guide surface | | |
| 116 | guide surface | | |
| 117 | partial cutting body | | |
| 118 | partial cutting body | | |
| 127 | holding element | | |
| 128 | wedge structure | | |
| 129 | wedge peak | | |
| 135 | working head | | |

1-21. (canceled)

22. A pair of tool parts for a stripping tool comprising:
a pair of tool jaws, which are configured to be brought together in an engagement direction for a stripping process, having a first tool jaw and a second tool jaw,
wherein the tool jaws are carriers of a first tool part and a second tool part which are configured to strip a cable having a cable core and an insulation sheath, wherein each tool part has a cutting body configured to receive a partial region of the cable,
each cutting body having at least two cutting parts, or a cutting part and a holding element, each cutting part comprising a cutting edge configured to act on the cable during a stripping process, wherein the cutting edge limits a free space of the cutting body, in which it is provided to receive the cable core,
each of the tool parts having a tool part base holding the cutting body, which tool part base is received on the respective tool jaw,
the cutting body having a first partial cutting body and a second partial cutting body which can be displaced in opposite axial directions relative to one another and relative to the tool part bases orthogonally to the engagement direction,
each of the tool part bases and the partial cutting bodies having guide surfaces which are operatively connected to one another and which provide for the displacement of the cutting bodies, the guide surfaces extending at a same obtuse angle with respect to the engagement direction of the tool jaws,
wherein an application of force to the cutting body can be attained solely by a displacement of the tool jaws in the engagement direction, which application of force leads to a displacement of the guide surfaces of each of the cutting bodies, and thus of the partial cutting bodies into the opposite axial directions, relative to the guide surfaces of each of the tool part bases with a movement component corresponding to the angle in the axial direction,
the first partial cutting body having a first of the cutting parts or a holding element on a front region facing the second partial cutting body,
the second partial cutting body having a second of the cutting parts on a front region facing the first partial cutting body, and
the cutting body additionally has at least one of the following tool elements: an additional holding element arranged on the first partial cutting body, and an additional cutting part arranged on the second partial cutting body, wherein the additional holding element is configured to shift or remove a partial insulation section from the cable core.

23. A stripping tool comprising a pair of tool jaws being carrier of the pair of tool parts according to claim 22.

24. The stripping tool according to claim 23, wherein a distance between the first cutting parts or the holding element of the first partial cutting body and the additional cutting parts of the second partial cutting body is configured to be smaller in response to contacting front regions of the partial cutting bodies than a first stripping length of the cable, which is stripped by completely bringing together the tool jaws.

25. The stripping tool according to claim 23, wherein a distance between the second cutting parts of the second partial cutting body and the additional holding element of the first partial cutting body is smaller when front regions of the partial cutting bodies contact one another than a first stripping length of the cable, which is stripped by completely bringing together the tool jaws.

26. The stripping tool according to claim 23, wherein the additional holding element is a clamping element having a wedge-shaped slit, for fixing the cable in the slit in a clamping manner.

27. The stripping tool according to claim 23, wherein the additional holding element is configured to reversibly connected to the first partial cutting body or the second partial cutting body.

28. The stripping tool according to claim 23, wherein the additional cutting parts, based on the completely brought-together end position of the tool jaws, are formed to completely sever the cable, in that a cutting tip of the additional cutting parts leaves no free space for receiving the cable core.

29. The stripping tool according to claim 23, wherein the additional cutting parts has a cutting tip, which, based on the completely brought-together end position of the tool jaws limits a free space of the cutting body, in which it is provided to receive the cable core.

30. The stripping tool according to claim 23, wherein the additional cutting parts are configured to reversibly connected to the second partial cutting body.

31. The stripping tool according to claim 23, wherein the tool part base has a wedge structure comprising at least two guide surfaces, which run towards a common wedge peak in opposite axial directions.

32. The stripping tool according to claim 23, wherein an end stop for the cable received in the stripping tool.

33. The stripping tool according to claim 23,
wherein the tool part has a rod-shaped holding element, which is oriented parallel to the axial direction and which passes through at least one passage opening of the tool part in the axial direction, and
wherein the holding element, based on a circumferential direction of the holding element, at least partially passes through the cutting body and at least partially through at least one of the following tool elements: the cutting parts, the holding element, the additional holding element, the additional cutting parts, and a guide element.

34. The stripping tool according to claim 23, wherein several receiving regions configured to receive the cable are provided, wherein a first receiving region has the pair of tool parts comprising the cutting bodies and a second receiving region has at least one cutting part configured to sever the cable or at least one crimping part configured to crimp the cable with a pressed part,
wherein the receiving regions are located next to one another in a cross-sectional plane orthogonal to the axial direction.

35. A method for stripping a cable having a cable core and an insulation sheath in a stripping process, comprising:
arranging the cable between a first and a second tool jaw, which are configured to be brought together in an engagement direction for the stripping process, the tool jaws having two opposite cutting bodies, which each have at least two cutting parts, of a first tool part and of a second tool part;
bringing together the two tool parts in an engagement direction;
cutting an axial partial section of the insulation sheath of the cable by using the cutting parts of the tool parts;
displacing a first partial cutting body and a second partial cutting body of each of the cutting bodies relative to one another and relative to a tool part base of the tool part in opposite axial directions, which are oriented orthogonally to the engagement direction, wherein guide surfaces, which are operatively connected to one another and which extend at a same obtuse angle to the engagement direction, of the tool part base and of the partial cutting bodies provide for the displacement of the partial cutting bodies, wherein an application of force to the cutting bodies takes place solely by a displacement of one or both of the tool jaws in the engagement direction, which application of force leads to a displacement of the guide surfaces of the partial cutting bodies relative to the guide surfaces of the tool part base with a movement component in the axial direction corresponding to the angle;
separating a first cutting part or holding element arranged on a front region of the first partial cutting body facing the second partial cutting body from a second cutting parts arranged on a front region of the second partial cutting body facing the first partial cutting body;
wherein when separating the partial cutting bodies, simultaneously also displacing at least one of the following tool elements: an additional holding element arranged on the first partial cutting body, an additional cutting parts arranged on the second partial cutting body; and
stripping an axial partial section of the cable by shifting the insulation sheath relative to the cable core during the displacement of the partial cutting bodies relative to the tool part base.

36. The method according to claim 35, wherein the stripping of the axial partial section of the cable takes place in two partial steps, which are temporally separated from one another, wherein initially shifting the insulation sheath by a first stripping length relative to the cable core during a first partial step by bringing together the tool parts, wherein a user subsequently displaces the cable in the axial direction relative to the tool parts into a second position and wherein the user then shifts the insulation sheath by a second stripping length relative to the cable core in the second position during a second partial step by bringing together the tool parts once again.

37. The method according to claim 36, wherein after carrying out the first partial step and prior to carrying out the second partial step, the user positions the cable between the tool parts so that the first cutting parts or the holding element of the first partial cutting body and the additional holding element of the second partial cutting body lie within an axial partial section of the cable, which is stripped by the first stripping length, when the front regions of the partial cutting bodies contact one another.

38. The method according to claim 36, wherein after carrying out the first partial step and prior to carrying out the second partial step, the user positions the cable between the tool parts so that the second cutting parts of the second partial cutting body and an additional holding element of the first partial cutting body lie within an axial partial section of the cable, which is stripped by the first stripping length, when the front regions of the partial cutting bodies contact one another.

39. The method according to claim 35, wherein the additional cutting parts completely severs the cable when reaching a completely brought-together end position of the tool jaws.

40. The method according to claim 35, wherein the displacement of the partial cutting body relative to the tool part base takes place along at least one guide surface of a wedge structure sloping in the axial direction.
